(19) United States
(12) Patent Application Publication
(10) Pub. No.: US 2020/0183400 A1
(43) Pub. Date: Jun. 11, 2020

(54) RFID-BASED NAVIGATION OF AN AUTONOMOUS GUIDED VEHICLE

(71) Applicant: Microsoft Technology Licensing, LLC, Redmond, WA (US)

(72) Inventors: Nicholas Andrew Keehn, Kirkland, WA (US); Adolfo Bravo Ferreira, Poulsbo, WA (US); Winston Allen Saunders, Seattle, WA (US)

(21) Appl. No.: 16/216,998

(22) Filed: Dec. 11, 2018

(51) Int. Cl. G05D 1/02; G06K 7/10; H04W 4/33

(52) U.S. Cl. CPC G05D 1/028; G05D 2201/0216; H04W 4/33; G06K 7/10405

(57) ABSTRACT

Techniques are described herein that are capable of performing RFID-based navigation of an autonomous guided vehicle (AGV). An intended location of the AGV is determined based at least in part on a previously determined location of the AGV and further based at least in part on a calculated motion of the AGV from the previously determined location. The AGV includes an RFID device that is paired with RFID devices in an environment of the AGV. The RFID device of the AGV and one or more of the RFID devices in the environment may communicate in accordance with an RFID technique to enable the AGV to determine an actual location of the AGV. A reference location of the AGV on which navigation of the AGV is based is set to be the actual location rather than the intended location.

### BACKGROUND

An autonomous guided vehicle (AGV) is a machine that is configured to navigate its environment in absence of human control. For instance, the AGV may include processor(s) that are capable of causing the AGV to travel around objects in the environment to achieve tasks. A variety of techniques has been proposed to enable an AGV to navigate its environment. However, each such technique has its limitations. For instance, conventional AGVs often use visual aids, reflective tags, magnetic tape, and/or waypoints to navigate. However, visual aids and reflective tags typically require a direct line of sight, which may limit their utility. Reflective tags may be confused by other reflective surfaces. Magnetic tape and waypoints typically are placed on the floor and are therefore subject to damage over time.

### SUMMARY

Various approaches are described herein for, among other things, performing radio frequency identification-based (RFID-based) navigation of an autonomous guided vehicle (AGV). For instance, an RFID device at the AGV may communicate with RFID device(s) in an environment of the AGV to enable the AGV to determine an actual location of the AGV and then update a reference location that is used for navigation of the AGV if the actual location differs from an intended location of the AGV. Such communication may also enable the AGV to determine an actual orientation of the AGV and then update a reference orientation that is used for navigation of the AGV if the actual orientation differs from an intended orientation of the AGV. Examples of an RFID device include but are not limited to an active RFID reader, a passive RFID tag, and an active RFID tag. In one example, the AGV may include an active RFID reader that sends an interrogation signal to the RFID device(s) in the environment and that receives response signal(s) from the RFID device(s) to indicate the actual location of the AGV. In another example, the RFID device(s) in the environment may be RFID reader(s), which send interrogation signal(s) to the RFID device at the AGV. Upon receipt of the interrogation signal(s), the RFID device at the AGV may provide response signal(s). The active RFID reader(s) in the environment may then provide information, indicating the actual location of the AGV, to the AGV in response to receipt of the response signal(s).

In an example approach, an intended location of an AGV is determined based at least in part on a previously determined location of the AGV and further based at least in part on a calculated motion of the AGV from the previously determined location. An interrogation signal is transmitted from an active RFID reader at the AGV to RFID device(s) that are paired with the active RFID reader. An actual location of the AGV is determined based at least in part on response signal(s) that are received from the RFID device(s) in response to the interrogation signal. A reference location of the AGV on which navigation of the AGV is based is set to be the actual location rather than the intended location.

In another example approach, an intended location of an AGV is determined based at least in part on a previously determined location of the AGV and further based at least in part on a calculated motion of the AGV from the previously determined location. Interrogation signal(s) are received at an RFID device of the AGV from active RFID reader(s) that are paired with the RFID device of the AGV. Response signal(s) are transmitted from the RFID device of the AGV to the active RFID reader(s) in response to the interrogation signal(s). Information that indicates an actual location of the AGV is received. The actual location is based at least in part on the response signal(s). A reference location of the AGV on which navigation of the AGV is based is set to be the actual location rather than the intended location.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example RFID-based navigation system in accordance with an embodiment.

FIG. 2A is a block diagram showing an example path of an autonomous guided vehicle (AGV) in a facility in accordance with an embodiment.

FIG. 2B is a block diagram showing a modified path of the AGV shown in

FIG. 2A in accordance with an embodiment.

FIGS. 3, 4A-4B, 5, 7, 8A-8B, and 9 depict flowcharts of example methods for using paired RFID devices to navigate an AGV in accordance with embodiments.

FIGS. 6 and 10 are block diagrams of example AGVs in accordance with embodiments.

FIG. 11 depicts an example computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

### II. Example Embodiments

Example embodiments described herein are capable of performing radio frequency identification-based (RFID-based) navigation of an autonomous guided vehicle (AGV). For instance, an RFID device at the AGV may communicate with RFID device(s) in an environment of the AGV to enable the AGV to determine an actual location of the AGV and then update a reference location that is used for navigation of the AGV if the actual location differs from an intended location of the AGV. Such communication may also enable the AGV to determine an actual orientation of the AGV and then update a reference orientation that is used for navigation of the AGV if the actual orientation differs from an intended orientation of the AGV. Examples of an RFID device include but are not limited to an active RFID reader, a passive RFID tag, and an active RFID tag. In one example, the AGV may include an active RFID reader that sends an interrogation signal to the RFID device(s) in the environment and that receives response signal(s) from the RFID device(s) to indicate the actual location of the AGV. In another example, the RFID device(s) in the environment may be RFID reader(s), which send interrogation signal(s) to the RFID device at the AGV. Upon receipt of the interrogation signal(s), the RFID device at the AGV may provide response signal(s). The active RFID reader(s) in the environment may then provide information, indicating the actual location of the AGV, to the AGV in response to receipt of the response signal(s). It will be recognized that an active RFID reader may include an active RFID antenna (e.g., a RFID active array antenna).

Example techniques described herein have a variety of benefits as compared to conventional techniques for navigating an AGV. For instance, the example techniques may be capable of providing rough navigation for an AGV. It should be noted that rough navigation is different from fine navigation. For instance, rough navigation may be said to focus on accuracy; whereas fine navigation may be said to focus on precision. Rough navigation for an AGV is navigation that determines which object(s) among multiple objects in an environment of the AGV are identified by the AGV. The rough navigation may also determine an orientation of the AGV with reference to the object(s) identified by the AGV. Accordingly, the rough navigation may enable the AGV to recalibrate a reference location and/or a reference orientation on which navigation of the AGV is based. For example, the rough navigation may determine that the AGV is proximate a first set of objects associated with a first location in the environment, rather than a second set of objects associated with a second location in the environment where the AGV is intended to be located. In accordance with this example, the rough navigation may recalibrate the reference location of the AGV to be the first location rather than the second location. In further accordance with this example, the rough navigation may recalibrate the reference orientation of the AGV based at least in part on the reference location being the first location rather than the second location. Whereas, fine navigation for an AGV is navigation that determines a position and/or an orientation of the AGV in the context of a known relative position (e.g., location and/or orientation) of the AGV with reference to object(s) in the environment of the AGV. For instance, the fine navigation may provide more precise localization of the AGV with reference to known surfaces and/or waypoints after the rough navigation is performed. The fine navigation may use a light detection and ranging (LIDAR) or sound navigation and ranging (SONAR) technique to perform such localization. Although fine navigation may provide more precise localization of the AGV than rough navigation, the example techniques may provide rough navigation that is capable of determining the location of the AGV to within 10 centimeters (cm).

The example techniques may be capable of determining the actual location and/or the actual orientation of an AGV in spaces in which the location and orientation of an AGV is traditionally difficult to determine. For instance, such spaces may include buildings with unremarkable (e.g., uniform) aisle ways and/or hallways, buildings with relatively log aisle ways and/or hallways, and buildings having floor materials that are conducive to slippage. The AGV need not necessarily have a direct line of sight to objects or tags thereon in the environment of the AGV to determine location and/or orientation of the AGV. For instance, the RFID readers utilized by the example techniques may read through a variety of materials. The RFID devices described herein may be placed on any suitable surface, which may enable the RFID devices to be placed in locations where the RFID devices are not likely to be damaged. Accordingly, the example techniques may be more reliable some conventional techniques. The RFID devices utilized by the example techniques may be more readable and durable than other types of devices (e.g., visual aids, magnetic tape, reflective laser tags, and waypoints) that may be used by conventional techniques. The example techniques may enable the AGV to self-localize based at least in part on a unique identifier (ID) associated with the RFID device at the AGV (and not merely placement). The unique ID may facilitate identifying the AGV if the AGV is transferred between facilities.

The example techniques may reduce a cost associated with navigating an AGV. For instance, the example techniques may reduce a likelihood that the AGV will be damaged (e.g., due to a collision with object(s) in the AGV's environment) during navigation. The example techniques may obviate a need for a human to intervene in navigation of the AGV. For instance, the example techniques may reduce a likelihood that the AGV will become confused with regard to its location and/or orientation and shut down. Such a shutdown may result in a human needing to remove obstacles from a path of the AGV, reposition the AGV (e.g., change a location of the AGV and/or change a direction in which the AGV is directed), and/or reprogram the AGV to enable the AGV to resume its navigation. Example techniques that utilize RFID technology to perform asset tracking and/or inventory control in addition to navigation of the AGV may cost less to implement and scale than some conventional techniques. The example techniques may increase an efficiency with which the AGV navigates through its environment, as compared to conventional techniques.

The example techniques may be capable of performing corrective actions to increase accuracy of the rough navigation of the AGV. For instance, the example techniques may (e.g., automatically) modify a computer program that controls a path of the AGV to avoid regions in which the actual location and/or orientation of the AGV is likely to be different from an intended location and/or orientation of the AGV; provide a recommendation to relocate or add RFID device(s) in the environment of the AGV; and/or narrow a coverage geometry of an active RFID reader that is used to facilitate the navigation of the AGV in regions in which the actual location and/or orientation of the AGV is likely to be different from an intended location and/or orientation of the AGV.

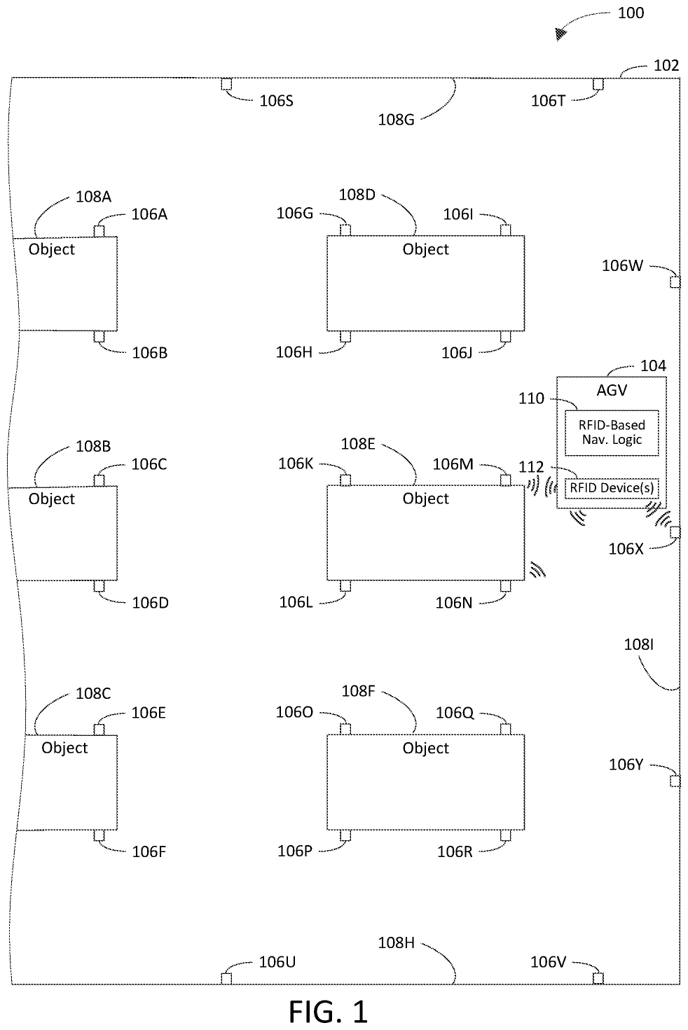

FIG. 1 is a block diagram of an example RFID-based navigation system 100 in accordance with an embodiment. Generally speaking, RFID-based navigation system 100 operates to perform RFID-based navigation of an AGV 104. For instance, the AGV 104 may be navigated along aisle ways in a facility 102 (e.g., a colocation center) as depicted in FIG. 1, though the scope of the example embodiments is not limited in this respect. In one example implementation, RFID-based navigation system 100 is a simultaneous location and mapping-based (SLAM-based) navigation system. As shown in FIG. 1, RFID-based navigation system 100 includes the AGV 104, a plurality of RFID devices 106A-106Y, and a plurality of objects 108A-108F. The plurality of RFID devices 106A-106Y are attached to the plurality of objects 108A-108F. More particularly, RFID devices 106A-106B are attached to object 108A; RFID devices 106C-106D are attached to object 108B; RFID devices 106E-106F are attached to object 108C; RFID devices 106G-106J are attached to object 108D; RFID devices 106K-106N are attached to object 108E; RFID devices 106O-106R are attached to object 108F; RFID devices 106S-106T are attached to object 108G; RFID devices 106U-106V are attached to object 108H; and RFID devices 106W-106Y are attached to object 108I. The arrangement of the RFID devices 106A-106Y with regard to the objects 108A-108I is provided for illustrative purposes and is not intended to be limiting. It will be recognized that RFID-based navigation system 100 may include any number of RFID devices 106A-106Y and any number of objects 108A-108I. Moreover, any of the RFID devices 106A-106Y may be attached to any of the objects 108A-108I. The RFID devices 106A-106Y may be positionally located in the facility 102, meaning that a location of each of the RFID devices 106A-106Y is known. Objects 108A-108F may be server racks in a colocation facility, and objects 108G-108I may be respective walls of the colocation facility, though the scope of the example embodiments is not limited in this respect.

AGV 104 is configured to be a processing system that is capable of navigating its environment in absence of human control. An example of a processing system is a system that includes at least one processor that is capable of manipulating data in accordance with a set of instructions. AGV 104 includes RFID-based navigation logic 110 and RFID device(s) 112. RFID device(s) 112 are paired with the plurality of RFID devices 106A-106Y. In one example implementation, RFID devices(s) 112 are active RFID reader(s) that generate signal(s) to interrogate RFID devices 106A-106Y, causing the RFID devices 106A-106Y that are within range of RFID device(s) 112 to provide response signals to RFID device(s) 112. Each response signal may uniquely identify the RFID device that provides the respective response signal. In accordance with this implementation, RFID device(s) 112 provide information regarding the response signals to RFID-based navigation logic 110 for processing to facilitate navigation of AGV 104. In another example implementation, RFID devices 106A-106Y are active RFID readers that are configured to interrogate RFID device(s) 112, causing RFID device(s) 112 to provide response signal(s) to the RFID device(s) 106A-106Y that are within range of RFID device(s) 112. In further accordance with this implementation, the RFID device(s) 106A-106Y that are within range of the RFID device(s) 112 provide information regarding the response signal(s) to AGV 104 for processing to facilitate navigation of AGV 104. For instance, the RFID device(s) 106A-106Y that are within range of the RFID device(s) 112 may provide the information via a network using well-known network communication protocols. The network may be a wide-area network (e.g., the Internet), a local area network (LAN), another type of network, or a combination thereof. RFID-based navigation logic 110 may process the information received from RFID device(s) 112 and/or one or more of RFID device(s) 106A-106Y to navigate AGV 104.

In the embodiment of FIG. 1, RFID devices 106M, 106N, and 106X are depicted to be within range of RFID device(s) 112 (i.e., are in close enough proximity to RFID device(s) 112 to communicate with RFID device(s) 112), and the other RFID devices 106A-L, 106O-106W, and 106Y are depicted to not be within range of RFID device(s) 112 (i.e., are not in close enough proximity to RFID device(s) 112 to communicate with RFID device(s) 112), for non-limiting illustrative purposes. Accordingly, RFID devices 106M, 106N, and 106X and RFID devices 112 communicate to generate the information that is provided to RFID-based navigation logic 110 for processing.

In one example implementation of this embodiment, RFID-based navigation logic 110 determines an intended location of AGV 104 based at least in part on a previously determined location of AGV 104 and further based at least in part on a calculated motion of AGV 104 from the previously determined location. In accordance with this implementation, RFID device(s) 112 include an active RFID reader that transmits an interrogation signal to at least RFID devices 106M, 106N, and 106X. In further accordance with this implementation, RFID-based navigation logic 110 determines an actual location of AGV 104 based at least in part on response signal(s) that are received from RFID devices 106M, 106N, and 106X in response to the interrogation signal. In further accordance with this implementation, RFID-based navigation logic 110 sets a reference location of AGV 104 on which navigation of AGV 104 is based to be the actual location rather than the intended location.

In another example implementation of this embodiment, RFID-based navigation logic 110 determines an intended location of AGV 104 based at least in part on a previously determined location of AGV 104 and further based at least in part on a calculated motion of AGV 104 from the previously determined location. In accordance with this implementation, RFID device(s) 112 receive interrogation signals from RFID devices 106M, 106N, and 106X. In accordance with this implementation, each of the RFID devices 106M, 106N, and 106X includes an active RFID reader. In further accordance with this implementation, RFID device(s) 112 transmit response signals to RFID devices 106M, 106N, and 106X in response to the interrogation signals. In further accordance with this implementation, RFID-based navigation logic 110 receives information that indicates an actual location of AGV 104. The actual location is based at least in part on the response signals. In further accordance with this implementation, RFID-based navigation logic 110 sets a reference location of AGV 104 on which navigation of AGV 104 is based to be the actual location rather than the intended location.

In some example embodiments, RFID-based navigation logic 110 is configured to use software automation to determine locations at which RFID device(s) 106A-106Y are to be located in facility 102 based at least in part on a blueprint of facility 102. For instance, RFID-based navigation logic 110 may take into consideration any of a variety of factors to determine the locations. Examples of such a factor include but are not limited to an operational range of the RFID devices 106A-106Y, radio-frequency interference being present in one or more regions in facility 102, likelihood of the RFID devices 106A-106Y to be moved or damaged in the locations, a size of facility 102, a coefficient of friction of a floor in facility 102, a likelihood that AGV 104 will encounter an obstacle in one or more regions of facility 102, a length of aisle ways or hallways in facility 102, and a number of aisle ways or hallways in facility 102.

RFID-based navigation logic 110 may be implemented in various ways to perform RFID-based navigation of AGV 104, including being implemented in hardware, software, firmware, or any combination thereof. For example, RFID-based navigation logic 110 may be implemented as computer program code configured to be executed in one or more processors. In another example, RFID-based navigation logic 110 may be implemented as hardware logic/electrical circuitry. For instance, RFID-based navigation logic 110 may be implemented in a field-programmable gate array (FPGA), an application-specific integrated circuit (ASIC), an application-specific standard product (ASSP), a system-on-a-chip system (SoC), a complex programmable logic device (CPLD), etc. Each SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

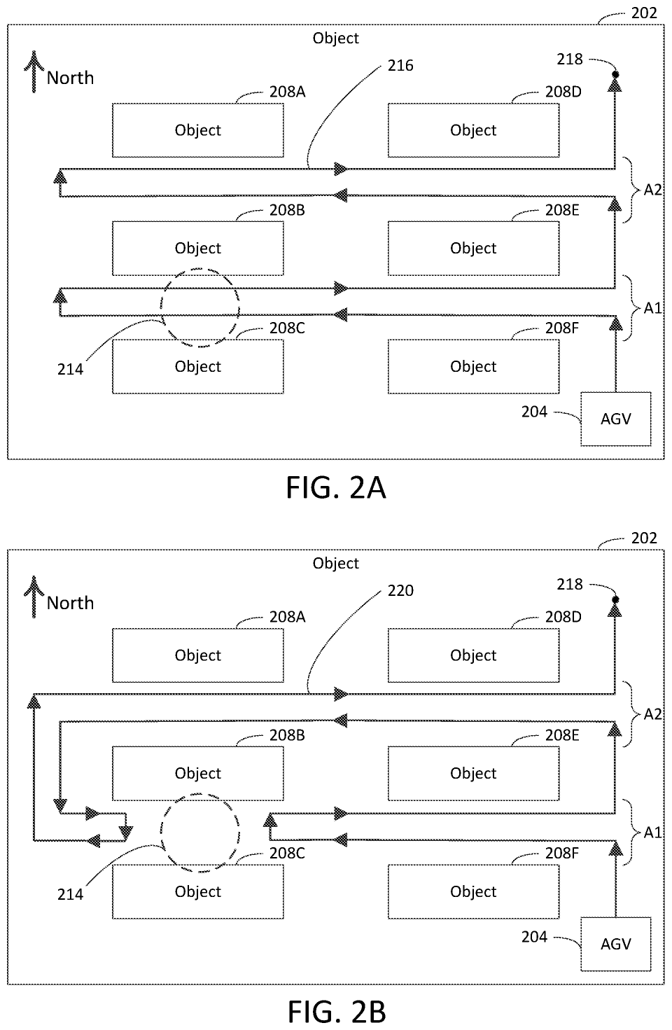

FIG. 2A is a block diagram showing an example path 216 of an AGV 204 in a facility 202 in accordance with an embodiment. As shown in FIG. 2A, the facility includes the AGV 204 and a plurality of objects 108A-108F. AGV 204 is configured to travel along path 216. In particular, AGV 204 is configured to travel northward until AGV 204 reaches aisle A1. AGV 204 is configured to turn left and travel westward along aisle A1, passing objects 208B-208C and 208E-208F along the way. AGV 204 is configured to turn around 180 degrees once AGV 204 passes objects 208B-208C and travel eastward along aisle A1, again passing objects 208B-208C and 208E-208F along the way. AGV 204 is configured to turn left once AGV 204 passes objects 208E-208F and travel northward until AGV 204 reaches aisle A2. AGV 204 is configured to turn left and travel westward along aisle A2, passing objects 208A-208B and 208D-208E along the way. AGV 204 is configured to turn around 180 degrees once AGV 204 passes objects 208A-208B and travel eastward along aisle A2, again passing objects 208A-208B and 208D-208E along the way. AGV 204 is configured to turn left once AGV 204 passes objects 208D-208E and travel northward until AGV 204 reaches a stopping location 218.

As AGV 204 travels along path 216, AGV 204 communicates with RFID devices (not shown) in facility 202 at various time instances to determine an actual location and/or an actual orientation of AGV 204 at each of the time instances. AGV 204 compares the actual location of AGV 204 with an intended location of AGV 204 and/or the actual orientation of AGV 204 with an intended orientation of AGV 204 for each time instance to determine whether a reference location and/or a reference orientation of AGV 204 upon which navigation of 204 is based is to be modified. For instance, modification of the reference location and/or the reference orientation associated with a time instance may compensate for a difference between the actual and intended locations and/or orientations for the time instance.

As shown in FIG. 2A, AGV 204 identifies a region 214 (a.k.a. dead spot) at which navigation of AGV 204 may be compromised. More particularly, AGV 204 may determine that the actual and intended locations and/or the actual and intended orientations of AGV 204 that are determined as AGV 204 moves through region 214 are likely to be different. AGV 204 may perform any of a variety of techniques to reduce a likelihood that navigation of AGV 204 will be compromised at region 214. One possible technique is for AGV 204 to change path 216 to avoid region 214.

FIG. 2B is a block diagram showing a modified path 218 of the AGV 204 shown in FIG. 2A in accordance with an embodiment. AGV 204 determines modified path 218 my modifying path 216 shown in FIG. 2A to avoid region 214. AGV 204 configures itself to travel along modified path 218. As shown in FIG. 2B, AGV 204 is configured to travel northward until AGV 204 reaches aisle A1. AGV 204 is configured to turn left and travel westward along aisle A1, passing objects 208E-208F along the way. AGV 204 is configured to turn around 180 degrees as AGV 204 approaches region 214 and to travel eastward along aisle A1, again passing objects 208E-208F along the way. AGV 204 is configured to turn left once AGV 204 passes objects 208E-208F and travel northward until AGV 204 reaches aisle A2. AGV 204 is configured to turn left and travel westward along aisle A2, passing objects 208A-208B and 208D-208E along the way. AGV 204 is configured to turn left once AGV 204 passes objects 208A-208B and travel southward until AGV 204 reaches aisle A1. AGV is configured to turn left and travel eastward along aisle A1 a short distance until AGV 204 approaches region 214. AGV 204 is configured to turn around 180 degrees as AGV 204 approaches region 214 and to travel westward along aisle A1. AGV 204 is configured to turn right as AGV 204 passes objects 208B and 208C and travel northward until AGV reaches aisle A2. AGV 204 is configured to turn right and travel eastward along aisle A2, again passing objects 208A-208B and 208D-208E along the way. AGV 204 is configured to turn left once AGV 204 passes objects 208D-208E and travel northward until AGV 204 reaches the stopping location 218.

It should be noted that path 216 of FIG. 2A and modified path 220 of FIG. 2B are provided for non-limiting illustrative purposes. It will be recognized that AGV 204 may be configured to follow any suitable path, and AGV 204 may modify its path in any suitable way to avoid any number of dead spots.

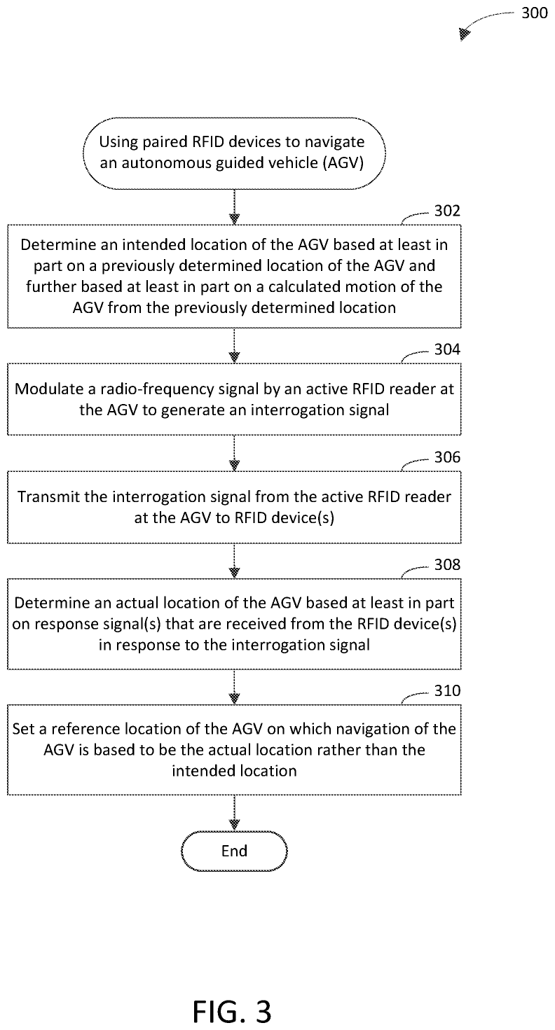

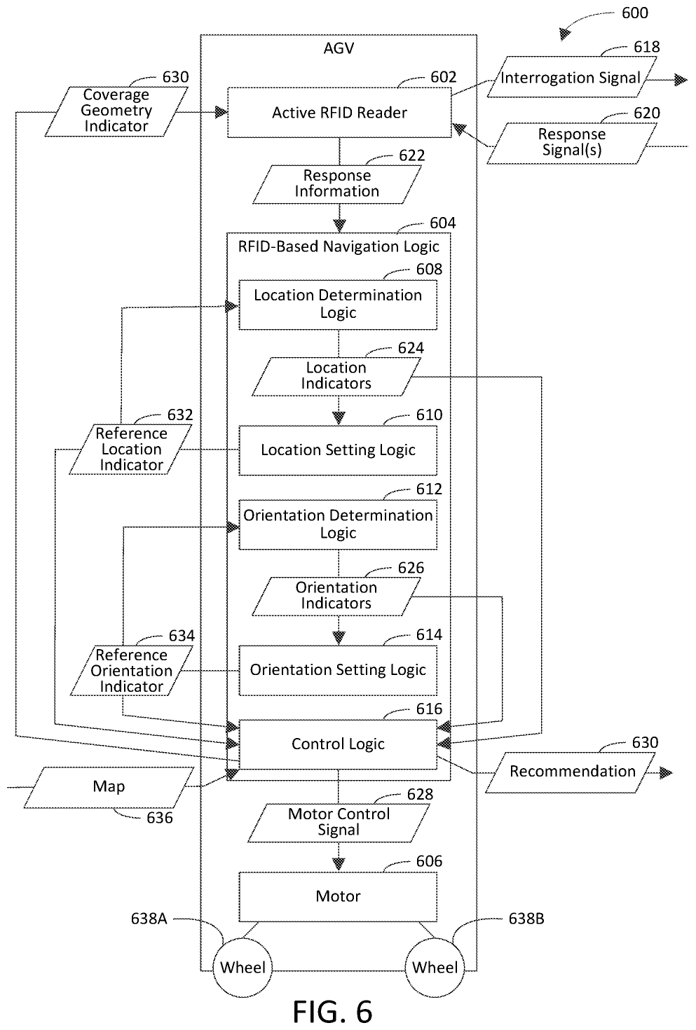

FIGS. 3, 4A-4B, and 5 depict flowcharts 300, 400, and 500 of example methods for using paired RFID devices to navigate an AGV in accordance with embodiments. Flowcharts 300, 400, and 500 may be performed by AGV 104 shown in FIG. 1, for example. For illustrative purposes, flowcharts 300, 400, and 500 are described with respect to AGV 600 shown in FIG. 6, which is an example implementation of AGV 104, according to an embodiment. As shown in FIG. 6, AGV 600 includes an active RFID reader 602, RFID-based navigation logic 604, a motor 606, and wheels 638A-638B. RFID-based navigation logic 604 includes location determination logic 608, location setting logic 610, orientation determination logic 612, orientation setting logic 614, and control logic 616. Further structural and operational embodiments will be apparent to persons skilled in the relevant art(s) based on the discussion regarding flowcharts 300, 400, and 500.

As shown in FIG. 3, the method of flowchart 300 begins at step 302. In step 302, an intended location of the AGV is determined based at least in part on a previously determined location of the AGV and further based at least in part on a calculated motion of the AGV from the previously determined location. In an example implementation, location determination logic 608 determines the intended location of AGV 600 based at least in part on a previously determined location of AGV 600 and a calculated motion of AGV 600 from the previously determined location.

At step 304, a radio-frequency signal is modulated by an active RFID reader at the AGV to generate an interrogation signal. In an example implementation, active RFID reader 602 modulates the radio-frequency signal to generate interrogation signal 618.

At step 306, the interrogation signal is transmitted from the active RFID reader at the AGV to RFID device(s). For example, the interrogation signal may be transmitted from active antenna(s) of the active RFID reader. In accordance with this example, the active antenna(s) may be unidirectional narrow-field active RFID antenna(s). The RFID device(s) may be attached to computer equipment on one or more racks in a co-location center, though the scope of the example embodiments is not limited in this respect. The paired RFID devices include the active RFID reader and a plurality of RFID devices. The plurality of RFID devices are paired with the active RFID reader and are attached to object(s) in an environment of the AGV. The plurality of RFID devices include the RFID device(s) to which the interrogation signal is transmitted. In an example implementation, active RFID reader 602 transmits the interrogation signal 608 to the RFID device(s).

At step 308, an actual location of the AGV is determined based at least in part on response signal(s) that are received from the RFID device(s) in response to the interrogation signal. For example, the actual location of the AGV may be determined based at least in part on signal strength(s) of the respective response signal(s). In accordance with this example, a relatively higher signal strength of a response signal may indicate a relatively shorter distance between the AGV and the RFID device from which the response signal is received. In further accordance with this example, a relatively lower signal strength of a response signal may indicate a relatively longer distance between the AGV and the RFID device from which the response signal is received. In further accordance with this example, the actual location may be determined based at least in part on distances between the actual location and the RFID device(s) being inversely proportional to the signal strength(s) of the respective response signal(s) that are received from the respective RFID device(s).

In an example implementation, active RFID reader 602 receives response signal(s) 620 in response to interrogation signal 618. In accordance with this implementation, active RFID reader 602 provides response information 622 to RFID-based navigation logic 604. In further accordance with this implementation, the response information 622 indicates the actual location of AGV 600. In further accordance with this implementation, location determination logic 608 determines the actual location of AGV 600 based at least in part on the response information 622. In further accordance with this implementation, location determination logic 608 may generate location indicators 624, which indicate (e.g., specify) the intended location of AGV 600 and the actual location of AGV 600 (or a relative difference therebetween).

At step 310, a reference location of the AGV on which navigation of the AGV is based is set to be the actual location rather than the intended location. For instance, the reference location of the AGV may be set to be the actual location as a result of the calculated motion of the AGV from the previously determined location being different from an actual motion of the AGV from the previously determined location. In an example implementation, location setting logic 610 sets the reference location of AGV 600 on which navigation of AGV 600 is based to be the actual location rather than the intended location. In accordance with this implementation, location setting logic 610 may generate a reference location indicator 632, indicating that the reference location is set to be the actual location. It should be noted that location determination logic 608 may use the reference location indicator 632 to determine a subsequent intended location of AGV 600 in response to AGV 600 moving from the actual location that is indicated by the reference location indicator 632.

In an example embodiment, transmitting the interrogation signal at step 306 includes transmitting the interrogation signal from the active RFID reader at the AGV to passive RFID tag(s) that are paired with the RFID reader and that are attached to at least one of the object(s). In accordance with this embodiment, determining the actual location of the AGV at step 308 includes determining the actual location of the AGV based at least in part on the response signal(s) that are received from the passive RFID tag(s) in response to the interrogation signal.

In another example embodiment, transmitting the interrogation signal at step 306 includes transmitting the interrogation signal from the active RFID reader at the AGV to active RFID tag(s) that are paired with the RFID reader and that are attached to at least one of the object(s). In accordance with this embodiment, determining the actual location of the AGV at step 308 includes determining the actual location of the AGV based at least in part on the response signal(s) that are received from the active RFID tag(s) in response to the interrogation signal.

In yet another example embodiment, transmitting the interrogation signal at step 306 includes transmitting the interrogation signal from the active RFID reader at the AGV to other active RFID reader(s) that are paired with the RFID reader and that are attached to at least one of the object(s). In accordance with this embodiment, determining the actual location of the AGV at step 308 includes determining the actual location of the AGV based at least in part on the response signal(s) that are received from the other active reader(s) in response to the interrogation signal.

In still another example embodiment, determining the intended location at step 302 includes determining that the AGV is intended to be located in a first aisle of a facility. In accordance with this embodiment, determining the actual location at step 308 includes determining that the AGV is located in a second aisle of the facility that is different from the first aisle. In further accordance with this embodiment, setting the reference location at step 310 includes setting the reference location to be in the second aisle rather than in the first aisle.

In some example embodiments, one or more steps 302, 304, 306, 308, and/or 310 of flowchart 300 may not be performed. Moreover, steps in addition to or in lieu of steps 302, 304, 306, 308, and/or 310 may be performed. For instance, in an example embodiment, the method of flowchart 300 further includes navigating the AGV from the actual location to the intended location to compensate for a difference between the actual location and the intended location. In an example implementation, control logic 616 navigates AGV 600 from the actual location to the intended location. For example, control logic 616 may navigate AGV 600 based at least in part on the location indicators 624, which indicate the intended location and the actual location (or a relative difference therebetween). In accordance with this example, control logic 616 may calculate the difference between the intended location and the actual location, as indicated by the location indicators 624, or the location indicators 624 may indicate the relative difference between the intended location and the actual location. In further accordance with this example, control logic 616 may generate a motor control signal 628 that causes motor 606 to rotate wheels 638A-638B in a manner that navigates AGV 600 from the actual location to the intended location.

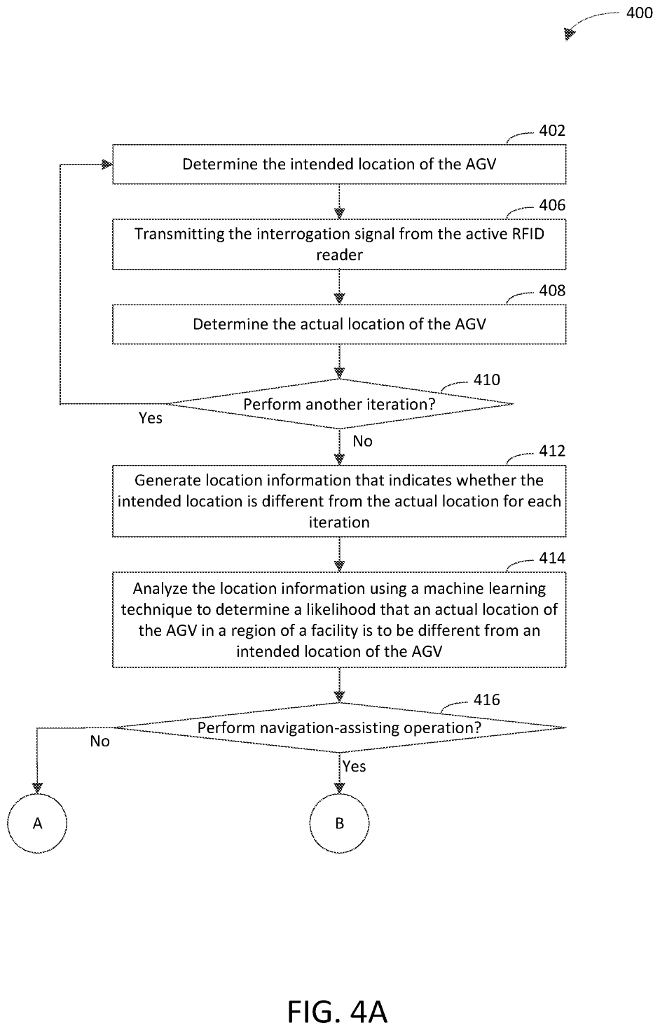

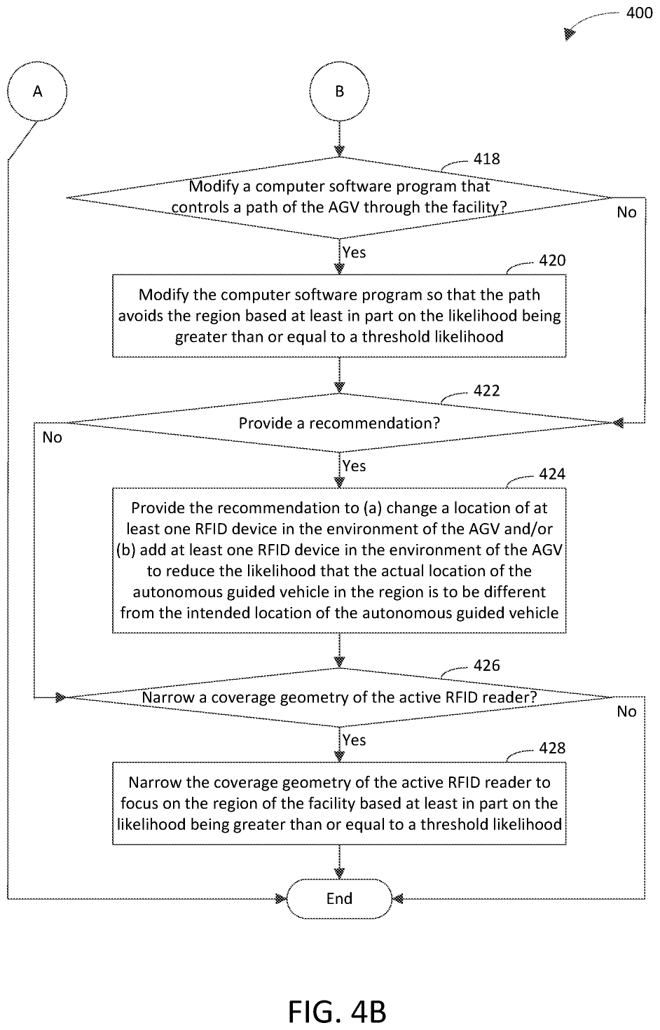

In another example embodiment, the method of flowchart 300 includes one or more steps of flowchart 400. FIGS. 4A and 4B show respective portions of flowchart 400. As shown in FIG. 4A, the method of flowchart 400 begins at step 402. In step 402, the intended location of the AGV is determined (as described at step 302). In an example implementation, location determination logic 608 determines the intended location of AGV 600.

At step 406, the interrogation signal is transmitted from the active RFID reader (as described at step 306). In an example implementation, active RFID reader 602 transmits interrogation signal 618.

At step 408, the actual location of the AGV is determined (as described at step 308). In an example implementation, location determination logic 608 determines the actual location of AGV 600.

At step 410, a determination is made whether another iteration of steps 402, 404, and 406 is to be performed. If another iteration is to be performed, flow returns to step 402. Otherwise, flow continues to step 412. In an example implementation, location determination logic 608 determines whether another iteration is to be performed.

At step 412, location information is generated that indicates whether the intended location is different from the actual location for each iteration. In an example implementation, location determination logic 608 generates the location information, which may include the location indicators 624, to indicate whether the intended location is different from the actual location for each iteration.

At step 414, the location information is analyzed using a machine learning technique to determine a likelihood (e.g., a machine learning-based confidence (ML-based confidence)) that an actual location of the AGV in a region of a facility is to be different from an intended location of the AGV. For instance, the facility may include the paired RFID devices. In an example implementation, control logic 616 analyzes the location information using the machine learning technique to determine the likelihood that an actual location of AGV 600 in the region of the facility is to be different from an intended location of AGV 600.

In some example embodiments, control logic 616 uses a neural network to perform the machine learning. Examples of a neural network include but are not limited to a feed forward neural network and a long short-term memory (LSTM) neural network. A feed forward neural network is an artificial neural network for which connections between units in the neural network do not form a cycle. The feed forward neural network allows data to flow forward (e.g., from the input nodes toward to the output nodes), but the feed forward neural network does not allow data to flow backward (e.g., from the output nodes toward to the input nodes). In an example embodiment, control logic 616 employs a feed forward neural network to train the machine learning model that is used to determine ML-based confidences.

An LSTM neural network is a recurrent neural network that has memory and allows data to flow forward and backward in the neural network. The LSTM neural network is capable of remembering values for short time periods or long time periods. Accordingly, the LSTM neural network may keep stored values from being iteratively diluted over time. In one example, the LSTM neural network may be capable of storing information regarding differences between intended locations and corresponding actual locations over time. For instance, the LSTM neural network may generate a model of an environment of the AGV 600 by utilizing such information. In another example, the LSTM neural network may be capable of remembering relationships between intended locations, actual location estimates, differences therebetween, confidences in the actual location estimates, confidences in the differences between the intended locations and the actual location estimates, and ML-based confidences that are derived therefrom.

Control logic 616 may include training logic and inference logic. The training logic is configured to train a machine learning algorithm that the inference logic uses to determine (e.g., infer) the ML-based confidences. For instance, the training logic may provide sample intended locations, sample actual location estimates, and sample confidences as inputs to the algorithm to train the algorithm. The sample data may be labeled. The machine learning algorithm may be configured to derive relationships between the intended locations, the actual location estimates, the differences therebetween, the confidences in the actual location estimates, the confidences in the differences between the intended locations and the actual location estimates, and the resulting ML-based confidences. The inference logic is configured to utilize the machine learning algorithm, which is trained by the training logic, to determine the ML-based confidence when the intended location of the AGV 600, the actual location estimate (and/or a difference therebetween), and a confidence in the actual location estimate (and/or a confidence in the difference between the intended location and the actual location estimate) are provided as inputs to the algorithm.

The machine learning techniques described herein are applicable to both rough navigation and fine navigation. The inputs can be determined with the rough navigation or without rough navigation aids. In an example embodiment, the machine learning is based at least in part on inputs from the fine navigation. In accordance with this embodiment, the machine learning may use inputs from the rough navigation. The machine learning may take into consideration a proposed path of the AGV 600 in a SLAM-based navigation system.

At step 416, a determination is made whether a navigation-assisting operation is to be performed. The determination may be made based at least in part on any of a variety of factors. Examples of such a factor include but are not limited to whether an amount of time that the AGV takes to travel along its path during any one or more periods of time is greater than or equal to a time threshold; whether an area covered by the path of the AGV is greater than or equal to an area threshold; whether a number of navigational errors that are made by the AGV along any one or more portions of its path is greater than or equal to an error threshold; and whether a confidence in a map that is used by the AGV to travel along its path is greater than or equal to a confidence threshold. If a navigation operation is to be performed, flow continues to step 418 shown in FIG. 4B. Otherwise, the method of flowchart 400 ends, as shown in FIG. 4B. In an example implementation, control logic 616 determines whether a navigation-assisting operation is to be performed.

At step 418, a determination is made whether to modify a computer software program that controls a path of the AGV through the facility. If the computer software program is to be modified, flow continues to step 420. Otherwise, flow continues to step 422. In an example implementation, control logic 616 determines whether to modify the computer software program that controls the path of AGV 600 through the facility. For instance, control logic 616 may make the determination based at least in part on any one or more of the example factors mentioned above with reference to step 416.

At step 420, the computer software program is modified so that the path avoids the region based at least in part on the likelihood being greater than or equal to a threshold likelihood. In an example implementation, control logic 616 modifies the computer software program.

At step 422, a determination is made whether to provide a recommendation. If a recommendation is to be provided, flow continues to step 424. Otherwise, flow continues to step 424. In an example implementation, control logic 616 determines whether to provide a recommendation 630. For instance, control logic 616 may make the determination based at least in part on any one or more of the example factors mentioned above with reference to step 416.

At step 424, the recommendation is provided to (a) change a location of at least one RFID device in the environment of the AGV and/or (b) add at least one RFID device in the environment of the AGV to reduce the likelihood that the actual location of the AGV in the region is to be different from the intended location of the AGV. In an example implementation, control logic 616 provides the recommendation 630 to (a) change a location of at least one RFID device in the environment of AGV 600 and/or (b) add at least one RFID device in the environment of AGV 600 to reduce the likelihood that the actual location of AGV 600 in the region is to be different from the intended location of AGV 600.

At step 426, a determination is made whether to narrow a coverage geometry of the active RFID reader. The coverage geometry of the active RFID reader indicates an extent to which the interrogation signal that is transmitted by the active RFID reader is focused on a region in the environment of the AGV toward which the interrogation signal is directed. For instance, the coverage geometry may indicate the size of a main lobe of the interrogation signal. Narrowing the coverage geometry increases the extent to which the interrogation signal is focused on the region. Accordingly, narrowing the coverage geometry may decrease the size of the main lobe of the interrogation signal. Broadening the coverage geometry decreases the extent to which the interrogation signal is focused on the region. Accordingly, broadening the coverage geometry may increase the size of the main lobe of the interrogation signal. It should be noted that an output energy associated with the interrogation signal may be increased in addition to or in lieu of narrowing the coverage geometry of the active RFID reader. If the coverage geometry is to be narrowed, flow continues to step 428. Otherwise, the method of flowchart 400 ends. In an example implementation, control logic 616 determines whether to narrow the coverage geometry of the active RFID reader. For instance, control logic 616 may make the determination based at least in part on any one or more of the example factors mentioned above with reference to step 416.

At step 428, the coverage geometry of the active RFID reader is narrowed to focus on the region of the facility based at least in part on the likelihood being greater than or equal to a threshold likelihood. Upon completion of step 428, the method of flowchart 400 ends. In an example implementation, control logic 616 narrows the coverage geometry of the active RFID reader.

In an aspect of this embodiment, the method of flowchart 400 further includes determining an amount of time that the AGV takes to travel through the region. For example, control logic 616 may determine the amount of time that AGV 600 takes to travel through the region. In accordance with this example, active RFID reader 602 may generate the response information to indicate time(s) at which the response signal(s) 620 are received. In further accordance with this example, location determination logic 624 may generate the location indicators 624 to indicate the time(s). In further accordance with this example, control logic 616 may determine the amount of time that AGV 600 takes to travel through the region based at least in part on the time(s) indicated by the location indicators 624. In accordance with this aspect, analyzing the location information at step 414 includes analyzing the location information and the amount of time that the AGV takes to travel through the region, using the machine learning technique, to determine the likelihood.

In another aspect of this embodiment, the method of flowchart 400 further includes determining an area of the facility that is covered by the path of the AGV. For example, control logic 616 may determine the area of the facility that is covered by the path of AGV 600. In accordance with this example, control logic 616 may analyze an outer boundary of a shape that is defined by the path of AGV 600 to determine the area of the facility that is covered by the path. In accordance with this aspect, analyzing the location information at step 414 includes analyzing the location information and an indication of the area of the facility that is covered by the path of the AGV using the machine learning technique to determine the likelihood.

In yet another aspect of this embodiment, the location information indicates a number of the iterations for which the actual location of the AGV in the region is different from the intended location of the AGV. In accordance with this aspect, analyzing the location information at step 414 includes analyzing the number of the iterations for which the actual location of the AGV in the region is different from the intended location of the AGV using the machine learning technique to determine the likelihood.

In still another aspect of this embodiment, the method of flowchart 400 further includes determining a confidence in an accuracy of a map of the facility using the machine learning technique. For instance, control logic 616 may determine the confidence in the accuracy of a map 636 of the facility using the machine learning technique. In an example implementation, control logic 616 may generate the map 636. In another implementation, control logic 616 may receive the map 636 from a source that is external to AGV 600. In accordance with this aspect, analyzing the location information at step 414 includes analyzing the location information and taking into consideration the confidence in the accuracy of the map of the facility using the machine learning technique to determine the likelihood.

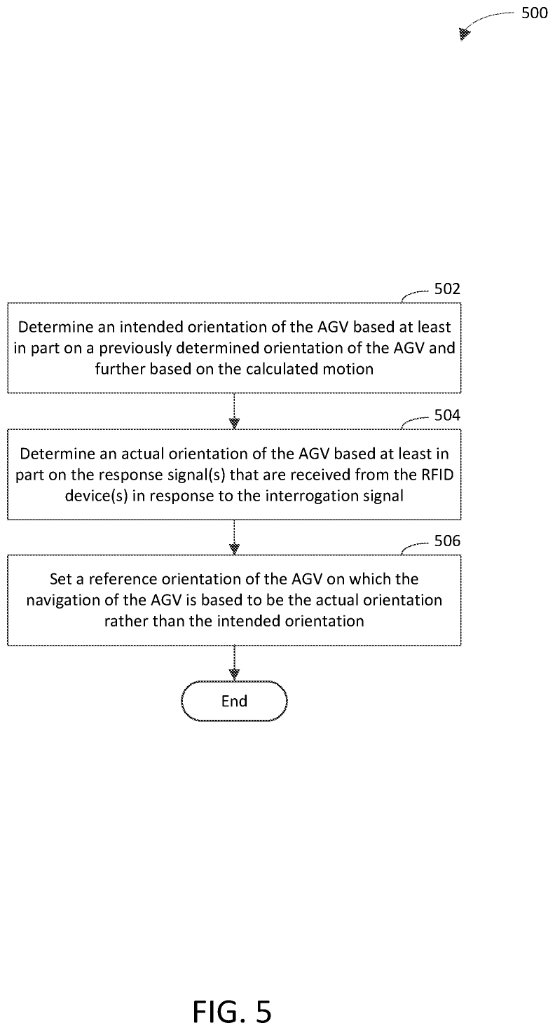

In yet another example embodiment, the method of flowchart 300 includes one or more steps of flowchart 500 shown in FIG. 5. As shown in FIG. 5, the method of flowchart 500 begins at step 502. In step 502, an intended orientation of the AGV is determined based at least in part on a previously determined orientation of the AGV and further based on the calculated motion. In an example implementation, orientation determination logic 612 determines the intended orientation of AGV 600 based at least in part on a previously determined orientation of AGV 600 and further based on the calculated motion of AGV 600.

At step 504, an actual orientation of the AGV is determined based at least in part on the response signal(s) that are received from the RFID device(s) in response to the interrogation signal. In an example implementation, the response information 622 provided by active RFID reader 602 indicates the actual orientation of AGV 600. In accordance with this implementation, orientation determination logic 612 determines the actual orientation of AGV 600 based at least in part on the response information 622. In further accordance with this implementation, orientation determination logic 612 may generate orientation indicators 626 to indicate (e.g., specify) the intended orientation of AGV 600 and the actual orientation of AGV 600 (or a relative difference therebetween).

At step 506, a reference orientation of the AGV on which the navigation of the AGV is based is set to be the actual orientation rather than the intended orientation. In an example implementation, orientation setting logic 614 sets the reference orientation of AGV 600 on which navigation of AGV 600 is based to be the actual orientation rather than the intended orientation. In accordance with this implementation, orientation setting logic 614 may generate a reference orientation indicator 634, indicating that the reference orientation is set to be the actual orientation. It should be noted that orientation determination logic 612 may use the reference orientation indicator 634 to determine a subsequent intended orientation of AGV 600 in response to AGV 600 moving from the actual orientation that is indicated by the reference orientation indicator 634.

It will be recognized that AGV 600 may not include one or more of active RFID reader 602, RFID-based navigation logic 604, motor 606, location determination logic 608, location setting logic 610, orientation determination logic 612, orientation setting logic 614, control logic 616, and/or wheels 638A-638B. Furthermore, AGV 600 may include components in addition to or in lieu of active RFID reader 602, RFID-based navigation logic 604, motor 606, location determination logic 608, location setting logic 610, orientation determination logic 612, orientation setting logic 614, control logic 616, and/or wheels 638A-638B.

For instance, in an example embodiment, AGV 600 includes rotation sensors that are configured to sense rotation of each of the wheels 638A-638B and an extent to which each of the wheels 638A-638B rotates. The rotation sensors may provide rotation information to location determination logic 608 and/or orientation determination logic 612. The rotation information may indicate an angular direction in which each of the wheels 638A-638B rotates and/or the extent to which each of the wheels 638A-638B rotates. The rotation information may enable location determination logic 608 to determine the intended location of AGV 600. Accordingly, location determination logic 608 may determine the intended location of AGV 600 based at least in part on the rotation information. The rotation information may enable orientation determination logic 612 to determine the intended orientation of AGV 600. Accordingly, orientation determination logic 612 may determine the intended orientation of AGV 600 based at least in part on the rotation information.

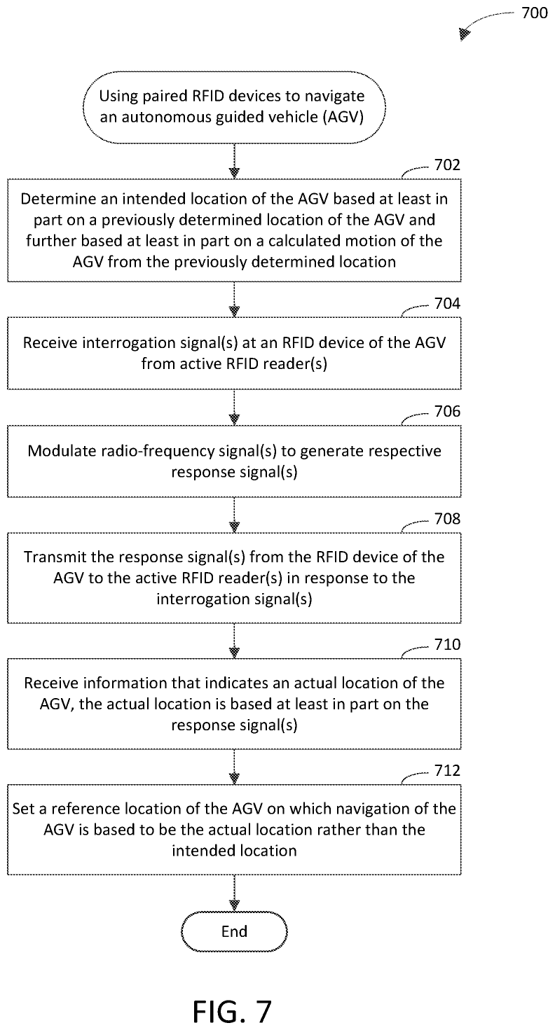

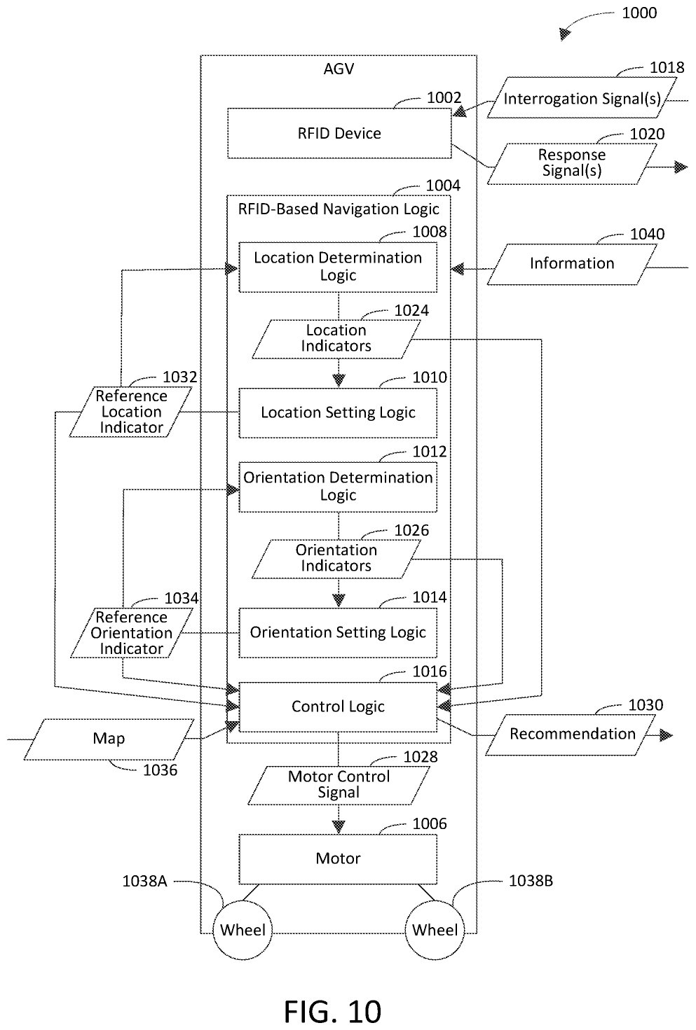

FIGS. 7, 8A-8B, and 9 depict flowcharts 700, 800, and 900 of example methods for using paired RFID devices to navigate an AGV in accordance with embodiments. Flowcharts 700, 800, and 900 may be performed by AGV 104 shown in FIG. 1, for example. For illustrative purposes, flowcharts 700, 800, and 900 are described with respect to AGV 1000 shown in FIG. 10, which is an example implementation of AGV 104, according to an embodiment. As shown in FIG. 10, AGV 1000 includes an RFID device 1002, RFID-based navigation logic 1004, a motor 1006, and wheels 1038A-1038B. RFID-based navigation logic 1004 includes location determination logic 1008, location setting logic 1010, orientation determination logic 1012, orientation setting logic 1014, and control logic 1016. Further structural and operational embodiments will be apparent to persons skilled in the relevant art(s) based on the discussion regarding flowcharts 700, 800, and 900.

As shown in FIG. 7, the method of flowchart 700 begins at step 702. In step 702, an intended location of the AGV is determined based at least in part on a previously determined location of the AGV and further based at least in part on a calculated motion of the AGV from the previously determined location. In an example implementation, location determination logic 1008 determines the intended location of AGV 1000 based at least in part on a previously determined location of AGV 1000 and a calculated motion of AGV 1000 from the previously determined location.

At step 704, interrogation signal(s) are received at an RFID device of the AGV from active RFID reader(s). The active RFID reader(s) may be attached to computer equipment on one or more racks in a co-location center, though the scope of the example embodiments is not limited in this respect. The paired RFID devices include the RFID device and a plurality of active RFID readers. The plurality of active RFID readers are paired with the RFID device and are attached to object(s) in an environment of the AGV. The plurality of active RFID readers include the active RFID reader(s) from which the interrogation signal(s) are received. In an example implementation, RFID device 1002 receives interrogation signal(s) 1018 from the active RFID reader(s).

At step 706, radio-frequency signal(s) are modulated to generate respective response signal(s). In an example implementation, RFID device 1002 modulates the radio-frequency signal(s) to generate response signal(s) 1020.

At step 708, the response signal(s) are transmitted from the RFID device of the

AGV to the active RFID reader(s) in response to the interrogation signal(s). For instance, the response signal(s) may indicate receipt of the interrogation signal(s) by the RFID device. In an example implementation, RFID device 1002 transmits the response signal(s) 1020 to the RFID reader(s) in response to the interrogation signal(s).

At step 710, information is received that indicates an actual location of the AGV. The actual location is based at least in part on the response signal(s). For example, the actual location of the AGV may be based at least in part on signal strength(s) of the respective response signal(s). In an example implementation, location determination logic 1008 receives information 1040 that indicates an actual location of AGV 600. For instance, location determination logic 1008 may receive the information 1040 via a network. In accordance with this implementation, the actual location of AGV 600 is based at least in part on the response signal(s) 1020. In further accordance with this implementation, location determination logic 1008 may generate location indicators 1024, which indicate (e.g., specify) the intended location of AGV 1000 and the actual location of AGV 1000 (or a relative difference therebetween).

At step 712, a reference location of the AGV on which navigation of the AGV is based is set to be the actual location rather than the intended location. For instance, the reference location of the AGV may be set to be the actual location as a result of the calculated motion of the AGV from the previously determined location being different from an actual motion of the AGV from the previously determined location. In an example implementation, location setting logic 1010 sets the reference location of AGV 1000 on which navigation of AGV 1000 is based to be the actual location rather than the intended location. In accordance with this implementation, location setting logic 1010 may generate a reference location indicator 1032, indicating that the reference location is set to be the actual location.

In an example embodiment, receiving the interrogation signal(s) at step 804 includes receiving the interrogation signal(s) at a passive RFID tag of the AGV from the active RFID reader(s). In accordance with this embodiment, transmitting the response signal(s) at step 806 includes transmitting the response signal(s) from the passive RFID tag of the AGV to the active RFID reader(s) in response to the interrogation signal(s).

In another example embodiment, receiving the interrogation signal(s) at step 804 includes receiving the interrogation signal(s) at an active RFID tag of the AGV from the active RFID reader(s). In accordance with this embodiment, transmitting the response signal(s) at step 806 includes transmitting the response signal(s) from the passive RFID tag of the AGV to the active RFID reader(s) in response to the interrogation signal(s).

In yet another example embodiment, receiving the interrogation signal(s) at step 804 includes receiving the interrogation signal(s) at an active RFID reader of the AGV from the active RFID reader(s). In accordance with this embodiment, transmitting the response signal(s) at step 806 includes transmitting the response signal(s) from the active RFID reader of the AGV to the active RFID reader(s) in response to the interrogation signal(s).

In still another example embodiment, determining the intended location at step 702 includes determining that the AGV is intended to be located in a first aisle of a facility. In accordance with this embodiment, an indicator indicates that the AGV is located in a second aisle of the facility that is different from the first aisle. In further accordance with this embodiment, setting the reference location at step 712 includes setting the reference location to be in the second aisle rather than in the first aisle.

In some example embodiments, one or more steps 702, 704, 706, 708, 710, and/or 712 of flowchart 700 may not be performed. Moreover, steps in addition to or in lieu of steps 702, 704, 706, 708, 710, and/or 712 may be performed. For instance, in an example embodiment, the method of flowchart 700 further includes navigating the AGV from the actual location to the intended location to compensate for a difference between the actual location and the intended location. In an example implementation, control logic 1016 navigates AGV 1000 from the actual location to the intended location. For example, control logic 1016 may navigate AGV 1000 based at least in part on the location indicators 1024, which indicate the intended location and the actual location (or a relative difference therebetween). In accordance with this example, control logic 1016 may calculate the difference between the intended location and the actual location, as indicated by the location indicators 1024, or the location indicators 1024 may indicate the relative difference between the intended location and the actual location. In further accordance with this example, control logic 1016 may generate a motor control signal 1028 that causes motor 1006 to rotate wheels 1038A-1038B in a manner that navigates AGV 1000 from the actual location to the intended location.

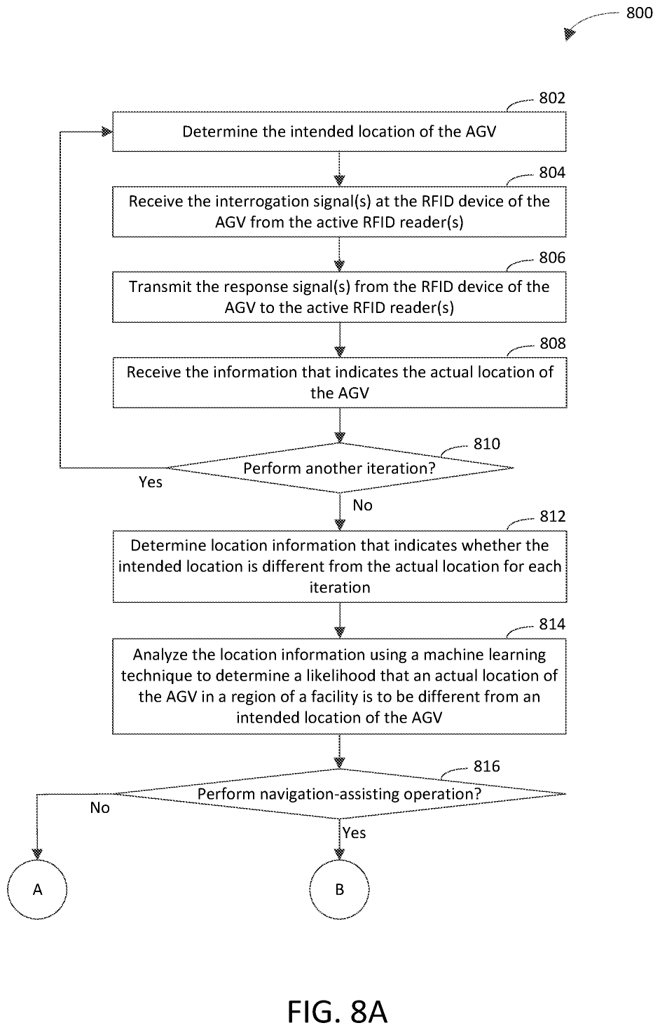

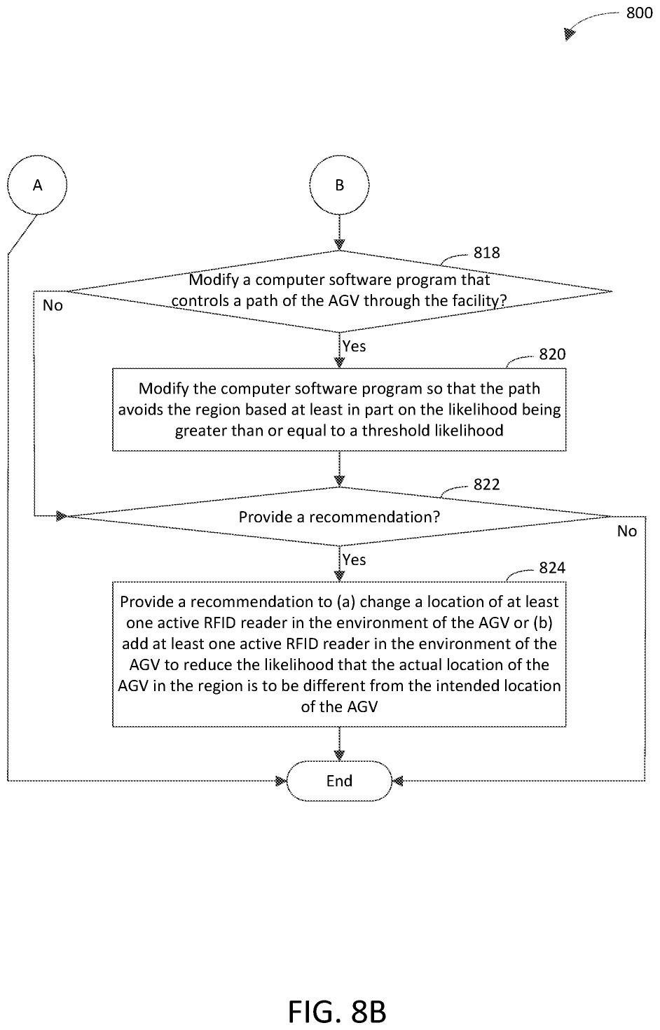

In another example embodiment, the method of flowchart 700 includes one or more steps of flowchart 800. FIGS. 8A and 8B show respective portions of flowchart 800. As shown in FIG. 8A, the method of flowchart 800 begins at step 802. In step 802, the intended location of the AGV is determined (as described at step 702). In an example implementation, location determination logic 1008 determines the intended location of AGV 1000.

At step 804, the interrogation signal(s) at the RFID device of the AGV are received from the active RFID reader(s) (as described at step 704). In an example implementation, RFID device 1002 receives the interrogation signal(s) 1018.

At step 806, the response signal(s) from the RFID device of the AGV are transmitted to the active RFID reader(s) (as described at step 708). In an example implementation, RFID device 1002 transmits the response signal(s) 1020 to the active RFID reader(s).

At step 808, the information that indicates the actual location of the AGV is received (as described at step 710). In an example implementation, location determination logic 1008 receives the information 1040 that indicates the actual location of AGV 1000.

At step 810, a determination is made whether another iteration of steps 802, 804, 806, and 808 is to be performed. If another iteration is to be performed, flow returns to step 802. Otherwise, flow continues to step 812. In an example implementation, location determination logic 1008 determines whether another iteration is to be performed.

At step 812, location information is determined that indicates whether the intended location is different from the actual location for each iteration. In an example implementation, location determination logic 1008 determines the location information, which may include the location indicators 1024.

At step 814, the location information is analyzed using a machine learning technique to determine a likelihood that an actual location of the AGV in a region of a facility is to be different from an intended location of the AGV. For instance, the facility may include the paired RFID devices. In an example implementation, control logic 1016 analyzes the location information using the machine learning technique to determine the likelihood that an actual location of AGV 1000 in the region of the facility is to be different from an intended location of AGV 1000.

At step 816, a determination is made whether a navigation-assisting operation is to be performed. If a navigation operation is to be performed, flow continues to step 818 shown in FIG. 8B. Otherwise, the method of flowchart 800 ends, as shown in FIG. 8B. In an example implementation, control logic 1016 determines whether a navigation-assisting operation is to be performed.

At step 818, a determination is made whether to modify a computer software program that controls a path of the AGV through the facility. If the computer software program is to be modified, flow continues to step 820. Otherwise, flow continues to step 822. In an example implementation, control logic 1016 determines whether to modify the computer software program that controls the path of AGV 1000 through the facility.

At step 820, the computer software program is modified so that the path avoids the region based at least in part on the likelihood being greater than or equal to a threshold likelihood. In an example implementation, control logic 1016 modifies the computer software program.

At step 822, a determination is made whether to provide a recommendation. If a recommendation is to be provided, flow continues to step 824. Otherwise, the method of flowchart 800 ends. In an example implementation, control logic 1016 determines whether to provide a recommendation 1030.

At step 824, the recommendation is provided to (a) change a location of at least one active RFID reader in the environment of the AGV or (b) add at least one active RFID reader in the environment of the AGV to reduce the likelihood that the actual location of the AGV in the region is to be different from the intended location of the AGV. Upon completion of step 824, the method of flowchart 800 ends. In an example implementation, control logic 1016 provides the recommendation 1030 to (a) change a location of at least one active RFID reader in the environment of AGV 1000 or (b) add at least one active RFID reader in the environment of AGV 1000 to reduce the likelihood that the actual location of AGV 1000 in the region is to be different from the intended location of AGV 1000.

In an aspect of this embodiment, the method of flowchart 800 further includes determining an amount of time that the AGV takes to travel through the region. For example, control logic 1016 may determine the amount of time that AGV 1000 takes to travel through the region. In accordance with this example, the information 1040 may indicate time(s) at which the response signal(s) 1020 are received by the active RFID reader(s). In further accordance with this example, location determination logic 1024 may generate the location indicators 1024 to indicate the time(s). In further accordance with this example, control logic 1016 may determine the amount of time that AGV 1000 takes to travel through the region based at least in part on the time(s) indicated by the location indicators 1024. In accordance with this aspect, analyzing the location information at step 814 includes analyzing the location information and the amount of time that the AGV takes to travel through the region, using the machine learning technique, to determine the likelihood.

In another aspect of this embodiment, the method of flowchart 800 further includes determining an area of the facility that is covered by the path of the AGV. For example, control logic 1016 may determine the area of the facility that is covered by the path of AGV 1000. In accordance with this aspect, analyzing the location information at step 814 includes analyzing the location information and an indication of the area of the facility that is covered by the path of the AGV using the machine learning technique to determine the likelihood.

In yet another aspect of this embodiment, the location information indicates a number of the iterations for which the actual location of the AGV in the region is different from the intended location of the AGV. In accordance with this aspect, analyzing the location information at step 814 includes analyzing the number of the iterations for which the actual location of the AGV in the region is different from the intended location of the AGV using the machine learning technique to determine the likelihood.

In still another aspect of this embodiment, the method of flowchart 800 further includes determining a confidence in an accuracy of a map of the facility using the machine learning technique. For instance, control logic 1016 may determine the confidence in the accuracy of a map 1036 of the facility using the machine learning technique. In accordance with this aspect, analyzing the location information at step 814 includes analyzing the location information and taking into consideration the confidence in the accuracy of the map of the facility using the machine learning technique to determine the likelihood.

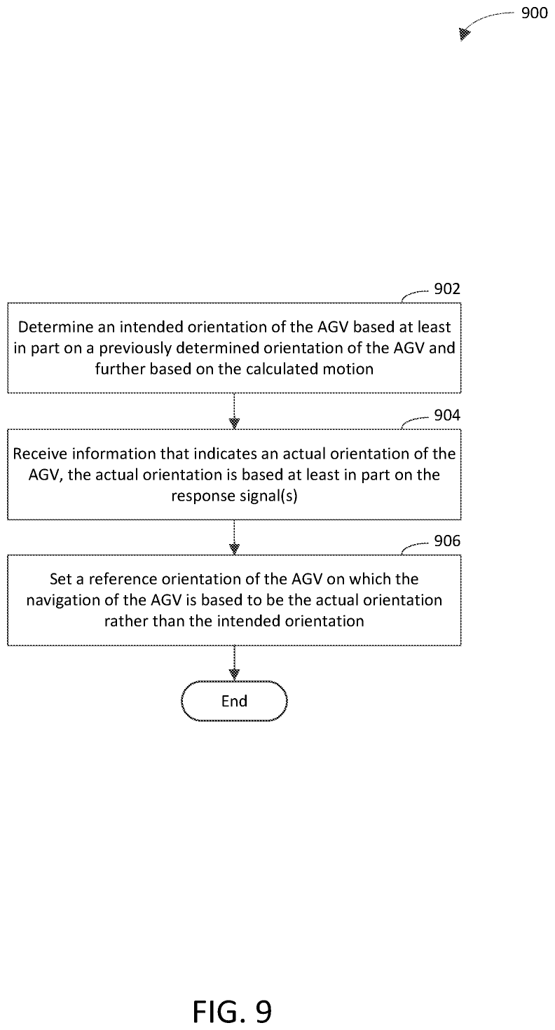

In yet another example embodiment, the method of flowchart 700 includes one or more steps of flowchart 900 shown in FIG. 9. As shown in FIG. 9, the method of flowchart 900 begins at step 902. In step 902, an intended orientation of the AGV is determined based at least in part on a previously determined orientation of the AGV and further based on the calculated motion. In an example implementation, orientation determination logic 1012 determines the intended orientation of AGV 1000 based at least in part on a previously determined orientation of AGV 1000 and further based on the calculated motion of AGV 1000.

At step 904, information that indicates an actual orientation of the AGV is received. The actual orientation is based at least in part on the response signal(s). In an example implementation, the information 1040 indicates the actual orientation of AGV 1000. In accordance with this implementation, orientation determination logic 1012 determines the actual orientation of AGV 1000 based at least in part on the information 1040. In further accordance with this implementation, orientation determination logic 1012 may generate orientation indicators 1026 to indicate (e.g., specify) the intended orientation of AGV 1000 and the actual orientation of AGV 1000 (or a relative difference therebetween).

At step 906, a reference orientation of the AGV on which the navigation of the AGV is based is set to be the actual orientation rather than the intended orientation. In an example implementation, orientation setting logic 1014 sets the reference orientation of AGV 1000 on which navigation of AGV 1000 is based to be the actual orientation rather than the intended orientation. In accordance with this implementation, orientation setting logic 1014 may generate a reference orientation indicator 1034, indicating that the reference orientation is set to be the actual orientation.

It will be recognized that AGV 1000 may not include one or more of active RFID reader 1002, RFID-based navigation logic 1004, motor 1006, location determination logic 1008, location setting logic 1010, orientation determination logic 1012, orientation setting logic 1014, control logic 1016, and/or wheels 1038A-1038B. Furthermore, AGV 1000 may include components in addition to or in lieu of active RFID reader 1002, RFID-based navigation logic 1004, motor 1006, location determination logic 1008, location setting logic 1010, orientation determination logic 1012, orientation setting logic 1014, control logic 1016, and/or wheels 1038A-1038B.

Any one or more of RFID-based navigation logic 110, RFID-based navigation logic 604, location determination logic 608, location setting logic 610, orientation determination logic 612, orientation setting logic 614, control logic 616, RFID-based navigation logic 1004, location determination logic 1008, location setting logic 1010, orientation determination logic 1012, orientation setting logic 1014, control logic 1016, flowchart 300, flowchart 400, flowchart 500, flowchart 700, flowchart 800, and/or flowchart 900 may be implemented in hardware, software, firmware, or any combination thereof.

For example, any one or more of RFID-based navigation logic 110, RFID-based navigation logic 604, location determination logic 608, location setting logic 610, orientation determination logic 612, orientation setting logic 614, control logic 616, RFID-based navigation logic 1004, location determination logic 1008, location setting logic 1010, orientation determination logic 1012, orientation setting logic 1014, control logic 1016, flowchart 300, flowchart 400, flowchart 500, flowchart 700, flowchart 800, and/or flowchart 900 may be implemented, at least in part, as computer program code configured to be executed in one or more processors.

In another example, any one or more of RFID-based navigation logic 110,

RFID-based navigation logic 604, location determination logic 608, location setting logic 610, orientation determination logic 612, orientation setting logic 614, control logic 616, RFID-based navigation logic 1004, location determination logic 1008, location setting logic 1010, orientation determination logic 1012, orientation setting logic 1014, control logic 1016, flowchart 300, flowchart 400, flowchart 500, flowchart 700, flowchart 800, and/or flowchart 900 may be implemented, at least in part, as hardware logic/electrical circuitry. Such hardware logic/electrical circuitry may include one or more hardware logic components. Examples of a hardware logic component include but are not limited to a field-programmable gate array (FPGA), an application-specific integrated circuit (ASIC), an application-specific standard product (ASSP), a system-on-a-chip system (SoC), a complex programmable logic device (CPLD), etc. For instance, a SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

### III. Further Discussion of Some Example Embodiments

A first example autonomous guided vehicle comprises memory, one or more processors, and an active RFID reader. The one or more processors are coupled to the memory. The one or more processors are configured to determine an intended location of the autonomous guided vehicle based at least in part on a previously determined location of the autonomous guided vehicle and further based at least in part on a calculated motion of the autonomous guided vehicle from the previously determined location. The active RFID reader is configured to transmit an interrogation signal to one or more RFID devices. The active RFID reader is paired with a plurality of RFID devices that are attached to one or more objects in an environment of the autonomous guided vehicle. The plurality of RFID devices includes the one or more RFID devices. The one or more processors are further configured to determine an actual location of the autonomous guided vehicle based at least in part on one or more response signals that are received from the one or more RFID devices in response to the interrogation signal. The one or more processors are further configured to set a reference location of the autonomous guided vehicle on which navigation of the autonomous guided vehicle is based to be the actual location rather than the intended location as a result of the calculated motion of the autonomous guided vehicle from the previously determined location being different from an actual motion of the autonomous guided vehicle from the previously determined location.

In a first aspect of the first example autonomous guided vehicle, the one or more processors are further configured to determine an intended orientation of the autonomous guided vehicle based at least in part on a previously determined orientation of the autonomous guided vehicle and further based on the calculated motion. In accordance with the first aspect, the one or more processors are further configured to determine an actual orientation of the autonomous guided vehicle based at least in part on the one or more response signals that are received from the one or more RFID devices in response to the interrogation signal. In further accordance with the first aspect, the one or more processors are further configured to set a reference orientation of the autonomous guided vehicle on which the navigation of the autonomous guided vehicle is based to be the actual orientation rather than the intended orientation as a result of the calculated motion of the autonomous guided vehicle from the previously determined location being different from the actual motion of the autonomous guided vehicle from the previously determined location.

In a second aspect of the first example autonomous guided vehicle, the one or more processors are configured to navigate the autonomous guided vehicle from the actual location to the intended location to compensate for a difference between the actual location and the intended location. The second aspect of the first example autonomous guided vehicle may be implemented in combination with the first aspect of the first example autonomous guided vehicle, though the example embodiments are not limited in this respect.

In a third aspect of the first example autonomous guided vehicle, the one or more processors are configured to determine that the autonomous guided vehicle is intended to be located in a first aisle of a facility. In accordance with the third aspect, the one or more processors are configured to determine that the autonomous guided vehicle is located in a second aisle of the facility that is different from the first aisle. In further accordance with the third aspect, the one or more processors are configured to set the reference location to be in the second aisle rather than in the first aisle. The third aspect of the first example autonomous guided vehicle may be implemented in combination with the first and/or second aspect of the first example autonomous guided vehicle, though the example embodiments are not limited in this respect.

In a fourth aspect of the first example autonomous guided vehicle, the one or more processors are configured to determine the actual location of the autonomous guided vehicle based at least in part on one or more signal strengths of the one or more respective response signals. The fourth aspect of the first example autonomous guided vehicle may be implemented in combination with the first, second, and/or third aspect of the first example autonomous guided vehicle, though the example embodiments are not limited in this respect.

In a fifth aspect of the first example autonomous guided vehicle, the active RFID reader includes one or more unidirectional narrow-field active RFID antennas. The fifth aspect of the first example autonomous guided vehicle may be implemented in combination with the first, second, third, and/or fourth aspect of the first example autonomous guided vehicle, though the example embodiments are not limited in this respect.

In an example method of using paired RFID devices to navigate an autonomous guided vehicle, an intended location of the autonomous guided vehicle is determined based at least in part on a previously determined location of the autonomous guided vehicle and further based at least in part on a calculated motion of the autonomous guided vehicle from the previously determined location. A radio-frequency signal is modulated by an active RFID reader at the autonomous guided vehicle to generate an interrogation signal. The interrogation signal is transmitted from the active RFID reader at the autonomous guided vehicle to one or more RFID devices. The paired RFID devices include the active RFID reader and a plurality of RFID devices that are paired with the active RFID reader and that are attached to one or more objects in an environment of the autonomous guided vehicle, the plurality of RFID devices including the one or more RFID devices. An actual location of the autonomous guided vehicle is determined based at least in part on one or more response signals that are received from the one or more RFID devices in response to the interrogation signal. A reference location of the autonomous guided vehicle on which navigation of the autonomous guided vehicle is based is set to be the actual location rather than the intended location as a result of the calculated motion of the autonomous guided vehicle from the previously determined location being different from an actual motion of the autonomous guided vehicle from the previously determined location.

In a first aspect of the example method, the example method further includes determining an intended orientation of the autonomous guided vehicle based at least in part on a previously determined orientation of the autonomous guided vehicle and further based on the calculated motion. In accordance with the first aspect, the example method further includes determining an actual orientation of the autonomous guided vehicle based at least in part on the one or more response signals that are received from the one or more RFID devices in response to the interrogation signal. In further accordance with the first aspect, the example method further includes setting a reference orientation of the autonomous guided vehicle on which the navigation of the autonomous guided vehicle is based to be the actual orientation rather than the intended orientation as a result of the calculated motion of the autonomous guided vehicle from the previously determined location being different from the actual motion of the autonomous guided vehicle from the previously determined location.

In a second aspect of the example method, transmitting the interrogation signal comprises transmitting the interrogation signal from the active RFID reader at the autonomous guided vehicle to one or more passive RFID tags that are paired with the RFID reader and that are attached to at least one of the one or more objects. In accordance with the second aspect, determining the actual location of the autonomous guided vehicle comprises determining the actual location of the autonomous guided vehicle based at least in part on the one or more response signals that are received from the one or more passive RFID tags in response to the interrogation signal. The second aspect of the example method may be implemented in combination with the first aspect of the example method, though the example embodiments are not limited in this respect.

In a third aspect of the example method, transmitting the interrogation signal comprises transmitting the interrogation signal from the active RFID reader at the autonomous guided vehicle to one or more active RFID tags that are paired with the RFID reader and that are attached to at least one of the one or more objects. In accordance with the third aspect, determining the actual location of the autonomous guided vehicle comprises determining the actual location of the autonomous guided vehicle based at least in part on the one or more response signals that are received from the one or more active RFID tags in response to the interrogation signal. The third aspect of the example method may be implemented in combination with the first and/or second aspect of the example method, though the example embodiments are not limited in this respect.

In a fourth aspect of the example method, transmitting the interrogation signal comprises transmitting the interrogation signal from the active RFID reader at the autonomous guided vehicle to one or more other active RFID readers that are paired with the RFID reader and that are attached to at least one of the one or more objects. In accordance with the fourth aspect, determining the actual location of the autonomous guided vehicle comprises determining the actual location of the autonomous guided vehicle based at least in part on the one or more response signals that are received from the one or more other active readers in response to the interrogation signal. The fourth aspect of the example method may be implemented in combination with the first, second, and/or third aspect of the example method, though the example embodiments are not limited in this respect.

In a fifth aspect of the example method, the one or more RFID devices are attached to computer equipment on one or more racks in a co-location center. The fifth aspect of the example method may be implemented in combination with the first, second, third, and/or fourth aspect of the example method, though the example embodiments are not limited in this respect.

In a sixth aspect of the example method, the example method comprises iteratively performing said determining the intended location, said transmitting the interrogation signal, and said determining the actual location of the autonomous guided vehicle to generate location information that indicates whether the intended location is different from the actual location for each iteration of a plurality of iterations. In accordance with the sixth aspect, the example method comprises analyzing the location information using a machine learning technique to determine a likelihood that an actual location of the autonomous guided vehicle in a region of a facility is to be different from an intended location of the autonomous guided vehicle, the facility including the paired RFID devices. In further accordance with the sixth aspect, the example method comprises performing at least one of the following operations: modifying a computer software program that controls a path of the autonomous guided vehicle through the facility so that the path avoids the region based at least in part on the likelihood being greater than or equal to a threshold likelihood; providing a recommendation to at least one of (a) change a location of at least one RFID device in the environment of the autonomous guided vehicle or (b) add at least one RFID device in the environment of the autonomous guided vehicle to reduce the likelihood that the actual location of the autonomous guided vehicle in the region is to be different from the intended location of the autonomous guided vehicle; or narrowing a coverage geometry of the active RFID reader to focus on the region of the facility based at least in part on the likelihood being greater than or equal to a threshold likelihood. The sixth aspect of the example method may be implemented in combination with the first, second, third, fourth, and/or fifth aspect of the example method, though the example embodiments are not limited in this respect.

In a first example of the sixth aspect, the example method further comprises determining an amount of time that the autonomous guided vehicle takes to travel through the region. In accordance with the first example, analyzing the location information comprises analyzing the location information and the amount of time that the autonomous guided vehicle takes to travel through the region, using the machine learning technique, to determine the likelihood.

In a second example of the sixth aspect, the example method further comprises determining an area of the facility that is covered by the path of the autonomous guided vehicle. In accordance with the second example, analyzing the location information comprises analyzing the location information and an indication of the area of the facility that is covered by the path of the autonomous guided vehicle using the machine learning technique to determine the likelihood.

In a third example of the sixth aspect, the location information indicates a number of the iterations for which the actual location of the autonomous guided vehicle in the region is different from the intended location of the autonomous guided vehicle. In accordance with the third example, analyzing the location information comprises analyzing the number of the iterations for which the actual location of the autonomous guided vehicle in the region is different from the intended location of the autonomous guided vehicle using the machine learning technique to determine the likelihood.

In a fourth example of the sixth aspect, the example method further comprises determining a confidence in an accuracy of a map of the facility using the machine learning technique. In accordance with the fourth example, analyzing the location information comprises analyzing the location information and taking into consideration the confidence in the accuracy of the map of the facility using the machine learning technique to determine the likelihood.

A second example autonomous guided vehicle comprises memory, one or more processors, and an RFID device. The one or more processors are coupled to the memory. The one or more processors are configured to determine an intended location of the autonomous guided vehicle based at least in part on a previously determined location of the autonomous guided vehicle and further based at least in part on a calculated motion of the autonomous guided vehicle from the previously determined location. The RFID device is configured to receive one or more interrogation signals from one or more active RFID readers. The RFID device is paired with a plurality of active RFID readers that are attached to one or more objects in an environment of the autonomous guided vehicle. The plurality of active RFID readers includes the one or more active RFID readers. The RFID device is further configured to transmit one or more response signals to the one or more active RFID readers in response to the one or more interrogation signals. The one or more response signals indicate receipt of the one or more interrogation signals by the RFID device. The one or more processors are further configured to set a reference location of the autonomous guided vehicle on which navigation of the autonomous guided vehicle is based to be an actual location of the autonomous guided vehicle, which is based at least in part on the one or more response signals, rather than the intended location as a result of the calculated motion of the autonomous guided vehicle from the previously determined location being different from an actual motion of the autonomous guided vehicle from the previously determined location.

In a first aspect of the second example autonomous guided vehicle, the one or more processors are further configured to determine an intended orientation of the autonomous guided vehicle based at least in part on a previously determined orientation of the autonomous guided vehicle and further based on the calculated motion. In accordance with the first aspect, the one or more processors are further configured to set a reference orientation of the autonomous guided vehicle on which the navigation of the autonomous guided vehicle is based to be an actual orientation of the autonomous guided vehicle, which is based at least in part on the one or more response signals, rather than the intended orientation as a result of the calculated motion of the autonomous guided vehicle from the previously determined location being different from the actual motion of the autonomous guided vehicle from the previously determined location.

In a second aspect of the second example autonomous guided vehicle, the RFID device includes a passive RFID tag. The second aspect of the second example autonomous guided vehicle may be implemented in combination with the first aspect of the second example autonomous guided vehicle, though the example embodiments are not limited in this respect.

In a third aspect of the second example autonomous guided vehicle, the RFID device includes an active RFID tag. The third aspect of the second example autonomous guided vehicle may be implemented in combination with the first and/or second aspect of the second example autonomous guided vehicle, though the example embodiments are not limited in this respect.

In a fourth aspect of the second example autonomous guided vehicle, the RFID device includes an active RFID reader. The fourth aspect of the second example autonomous guided vehicle may be implemented in combination with the first, second, and/or third aspect of the second example autonomous guided vehicle, though the example embodiments are not limited in this respect.

In a fifth aspect of the second example autonomous guided vehicle, the one or more processors and the RFID device are configured to collaborate to iteratively determine the intended location, receive the one or more interrogation signals, and transmit the one or more response signals, which results in location information that indicates whether the intended location is different from the actual location for each iteration of a plurality of iterations. In accordance with the fifth aspect, the one or more processors are configured to analyze the location information using a machine learning technique to determine a likelihood that an actual location of the autonomous guided vehicle in a region of a facility is to be different from an intended location of the autonomous guided vehicle, the facility including the paired RFID devices. In further accordance with the fifth aspect, the one or more processors are configured to perform at least one of the following operations: modify a computer software program that controls a path of the autonomous guided vehicle through the facility so that the path avoids the region based at least in part on the likelihood being greater than or equal to a threshold likelihood; or provide a recommendation to at least one of (a) change a location of at least one active RFID reader in the environment of the autonomous guided vehicle or (b) add at least one active RFID reader in the environment of the autonomous guided vehicle to reduce the likelihood that the actual location of the autonomous guided vehicle in the region is to be different from the intended location of the autonomous guided vehicle. The fifth aspect of the second example autonomous guided vehicle may be implemented in combination with the first, second, third, and/or fourth aspect of the second example autonomous guided vehicle, though the example embodiments are not limited in this respect.

### IV. Example Computer System

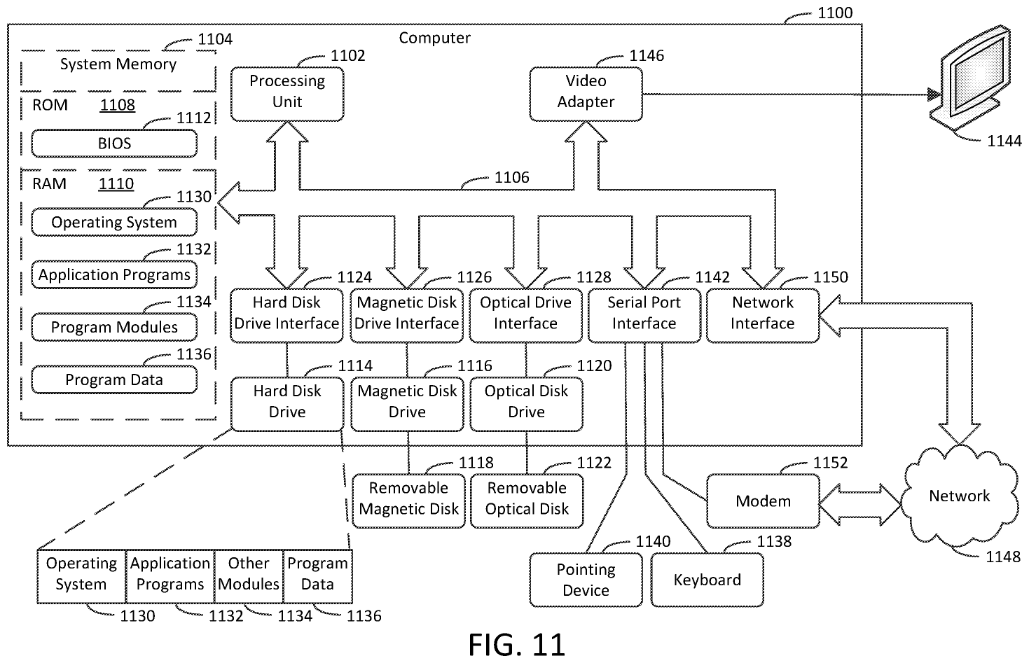

FIG. 11 depicts an example computer 1100 in which embodiments may be implemented. Any one or more of AGV 104, AGV 204, AGV 600, and AGV 1000 shown in respective FIGS. 1, 2, 6, and 10 may be implemented using computer 1100, including one or more features of computer 1100 and/or alternative features. Computer 1100 may be a general-purpose computing device in the form of a conventional personal computer, a mobile computer, or a workstation, for example, or computer 1100 may be a special purpose computing device. The description of computer 1100 provided herein is provided for purposes of illustration, and is not intended to be limiting. Embodiments may be implemented in further types of computer systems, as would be known to persons skilled in the relevant art(s).

As shown in FIG. 11, computer 1100 includes a processing unit 1102, a system memory 1104, and a bus 1106 that couples various system components including system memory 1104 to processing unit 1102. Bus 1106 represents one or more of any of several types of bus structures, including a memory bus or memory controller, a peripheral bus, an accelerated graphics port, and a processor or local bus using any of a variety of bus architectures. System memory 1104 includes read only memory (ROM) 1108 and random access memory (RAM) 1110. A basic input/output system 1112 (BIOS) is stored in ROM 1108.

Computer 1100 also has one or more of the following drives: a hard disk drive 1114 for reading from and writing to a hard disk, a magnetic disk drive 1116 for reading from or writing to a removable magnetic disk 1118, and an optical disk drive 1120 for reading from or writing to a removable optical disk 1122 such as a CD ROM, DVD ROM, or other optical media. Hard disk drive 1114, magnetic disk drive 1116, and optical disk drive 1120 are connected to bus 1106 by a hard disk drive interface 1124, a magnetic disk drive interface 1126, and an optical drive interface 1128, respectively. The drives and their associated computer-readable storage media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 1130, one or more application programs 1132, other program modules 1134, and program data 1136. Application programs 1132 or program modules 1134 may include, for example, computer program logic for implementing any one or more of RFID-based navigation logic 110, RFID-based navigation logic 604, location determination logic 608, location setting logic 610, orientation determination logic 612, orientation setting logic 614, control logic 616, RFID-based navigation logic 1004, location determination logic 1008, location setting logic 1010, orientation determination logic 1012, orientation setting logic 1014, control logic 1016, flowchart 300 (including any step of flowchart 300), flowchart 400 (including any step of flowchart 400), flowchart 500 (including any step of flowchart 500), flowchart 700 (including any step of flowchart 700), flowchart 800 (including any step of flowchart 800), and/or flowchart 900 (including any step of flowchart 900), as described herein.

A user may enter commands and information into the computer 1100 through input devices such as keyboard 1138 and pointing device 1140. Other input devices (not shown) may include a microphone, joystick, game pad, satellite dish, scanner, touch screen, camera, accelerometer, gyroscope, or the like. These and other input devices are often connected to the processing unit 1102 through a serial port interface 1142 that is coupled to bus 1106, but may be connected by other interfaces, such as a parallel port, game port, or a universal serial bus (USB).

A display device 1144 (e.g., a monitor) is also connected to bus 1106 via an interface, such as a video adapter 1146. In addition to display device 1144, computer 1100 may include other peripheral output devices (not shown) such as speakers and printers.

Computer 1100 is connected to a network 1148 (e.g., the Internet) through a network interface or adapter 1150, a modem 1152, or other means for establishing communications over the network. Modem 1152, which may be internal or external, is connected to bus 1106 via serial port interface 1142.

As used herein, the terms “computer program medium” and “computer-readable storage medium” are used to generally refer to media (e.g., non-transitory media) such as the hard disk associated with hard disk drive 1114, removable magnetic disk 1118, removable optical disk 1122, as well as other media such as flash memory cards, digital video disks, random access memories (RAMs), read only memories (ROM), and the like. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Example embodiments are also directed to such communication media.

As noted above, computer programs and modules (including application programs 1132 and other program modules 1134) may be stored on the hard disk, magnetic disk, optical disk, ROM, or RAM. Such computer programs may also be received via network interface 1150 or serial port interface 1142. Such computer programs, when executed or loaded by an application, enable computer 1100 to implement features of embodiments discussed herein. Accordingly, such computer programs represent controllers of the computer 1100.

Example embodiments are also directed to computer program products comprising software (e.g., computer-readable instructions) stored on any computer-useable medium. Such software, when executed in one or more data processing devices, causes data processing device(s) to operate as described herein. Embodiments may employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMS-based storage devices, nanotechnology-based storage devices, and the like.

It will be recognized that the disclosed technologies are not limited to any particular computer or type of hardware. Certain details of suitable computers and hardware are well known and need not be set forth in detail in this disclosure.

### V. Conclusion

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

What is claimed is:

1. An autonomous guided vehicle comprising:
memory;
one or more processors coupled to the memory, the one or more processors configured to determine an intended location of the autonomous guided vehicle based at least in part on a previously determined location of the autonomous guided vehicle and further based at least in part on a calculated motion of the autonomous guided vehicle from the previously determined location; and
an active RFID reader configured to transmit an interrogation signal to one or more RFID devices, the active RFID reader paired with a plurality of RFID devices that are attached to one or more objects in an environment of the autonomous guided vehicle, the plurality of RFID devices including the one or more RFID devices,
the one or more processors further configured to determine an actual location of the autonomous guided vehicle based at least in part on one or more response signals that are received from the one or more RFID devices in response to the interrogation signal,
the one or more processors further configured to set a reference location of the autonomous guided vehicle on which navigation of the autonomous guided vehicle is based to be the actual location rather than the intended location as a result of the calculated motion of the autonomous guided vehicle from the previously determined location being different from an actual motion of the autonomous guided vehicle from the previously determined location.

2. The autonomous guided vehicle of claim 1, wherein the one or more processors are further configured to:
determine an intended orientation of the autonomous guided vehicle based at least in part on a previously determined orientation of the autonomous guided vehicle and further based on the calculated motion;
determine an actual orientation of the autonomous guided vehicle based at least in part on the one or more response signals that are received from the one or more RFID devices in response to the interrogation signal; and
set a reference orientation of the autonomous guided vehicle on which the navigation of the autonomous guided vehicle is based to be the actual orientation rather than the intended orientation as a result of the calculated motion of the autonomous guided vehicle from the previously determined location being different from the actual motion of the autonomous guided vehicle from the previously determined location.

3. The autonomous guided vehicle of claim 1, wherein the one or more processors are configured to navigate the autonomous guided vehicle from the actual location to the intended location to compensate for a difference between the actual location and the intended location.

4. The autonomous guided vehicle of claim 1, wherein the one or more processors are configured to:
determine that the autonomous guided vehicle is intended to be located in a first aisle of a facility;
determine that the autonomous guided vehicle is located in a second aisle of the facility that is different from the first aisle; and
set the reference location to be in the second aisle rather than in the first aisle.

5. The autonomous guided vehicle of claim 1, wherein the one or more processors are configured to determine the actual location of the autonomous guided vehicle based at least in part on one or more signal strengths of the one or more respective response signals.

6. The autonomous guided vehicle of claim 1, wherein the active RFID reader includes one or more unidirectional narrow-field active RFID antennas.

7. A method of using paired RFID devices to navigate an autonomous guided vehicle, the method comprising:
determining an intended location of the autonomous guided vehicle based at least in part on a previously determined location of the autonomous guided vehicle and further based at least in part on a calculated motion of the autonomous guided vehicle from the previously determined location;
modulating a radio-frequency signal by an active RFID reader at the autonomous guided vehicle to generate an interrogation signal;
transmitting the interrogation signal from the active RFID reader at the autonomous guided vehicle to one or more RFID devices, the paired RFID devices including the active RFID reader and a plurality of RFID devices that are paired with the active RFID reader and that are attached to one or more objects in an environment of the autonomous guided vehicle, the plurality of RFID devices including the one or more RFID devices;
determining an actual location of the autonomous guided vehicle based at least in part on one or more response signals that are received from the one or more RFID devices in response to the interrogation signal; and
setting a reference location of the autonomous guided vehicle on which navigation of the autonomous guided vehicle is based to be the actual location rather than the intended location as a result of the calculated motion of the autonomous guided vehicle from the previously determined location being different from an actual motion of the autonomous guided vehicle from the previously determined location.

8. The method of claim 7, further comprising:
determining an intended orientation of the autonomous guided vehicle based at least in part on a previously determined orientation of the autonomous guided vehicle and further based on the calculated motion;
determining an actual orientation of the autonomous guided vehicle based at least in part on the one or more response signals that are received from the one or more RFID devices in response to the interrogation signal; and
setting a reference orientation of the autonomous guided vehicle on which the navigation of the autonomous guided vehicle is based to be the actual orientation rather than the intended orientation as a result of the calculated motion of the autonomous guided vehicle from the previously determined location being different from the actual motion of the autonomous guided vehicle from the previously determined location.

9. The method of claim 7, wherein transmitting the interrogation signal comprises:
transmitting the interrogation signal from the active RFID reader at the autonomous guided vehicle to one or more passive RFID tags that are paired with the RFID reader and that are attached to at least one of the one or more objects; and
wherein determining the actual location of the autonomous guided vehicle comprises:
determining the actual location of the autonomous guided vehicle based at least in part on the one or more response signals that are received from the one or more passive RFID tags in response to the interrogation signal.

10. The method of claim 7, wherein transmitting the interrogation signal comprises:
transmitting the interrogation signal from the active RFID reader at the autonomous guided vehicle to one or more active RFID tags that are paired with the RFID reader and that are attached to at least one of the one or more objects; and
wherein determining the actual location of the autonomous guided vehicle comprises:
determining the actual location of the autonomous guided vehicle based at least in part on the one or more response signals that are received from the one or more active RFID tags in response to the interrogation signal.

11. The method of claim 7, wherein transmitting the interrogation signal comprises:
transmitting the interrogation signal from the active RFID reader at the autonomous guided vehicle to one or more other active RFID readers that are paired with the RFID reader and that are attached to at least one of the one or more objects; and
wherein determining the actual location of the autonomous guided vehicle comprises:
determining the actual location of the autonomous guided vehicle based at least in part on the one or more response signals that are received from the one or more other active readers in response to the interrogation signal.

12. The method of claim 7, wherein the one or more RFID devices are attached to computer equipment on one or more racks in a co-location center.

13. The method of claim 7, comprising:
iteratively performing said determining the intended location, said transmitting the interrogation signal, and said determining the actual location of the autonomous guided vehicle to generate location information that indicates whether the intended location is different from the actual location for each iteration of a plurality of iterations;
analyzing the location information using a machine learning technique to determine a likelihood that an actual location of the autonomous guided vehicle in a region of a facility is to be different from an intended location of the autonomous guided vehicle, the facility including the paired RFID devices; and
performing at least one of the following operations:
modifying a computer software program that controls a path of the autonomous guided vehicle through the facility so that the path avoids the region based at least in part on the likelihood being greater than or equal to a threshold likelihood;
providing a recommendation to at least one of (a) change a location of at least one RFID device in the environment of the autonomous guided vehicle or (b) add at least one RFID device in the environment of the autonomous guided vehicle to reduce the likelihood that the actual location of the autonomous guided vehicle in the region is to be different from the intended location of the autonomous guided vehicle; or
narrowing a coverage geometry of the active RFID reader to focus on the region of the facility based at least in part on the likelihood being greater than or equal to a threshold likelihood.

14. The method of claim 13, further comprising:
determining an amount of time that the autonomous guided vehicle takes to travel through the region;
wherein analyzing the location information comprises:
analyzing the location information and the amount of time that the autonomous guided vehicle takes to travel through the region, using the machine learning technique, to determine the likelihood.

15. The method of claim 13, further comprising:
determining an area of the facility that is covered by the path of the autonomous guided vehicle;
wherein analyzing the location information comprises:
analyzing the location information and an indication of the area of the facility that is covered by the path of the autonomous guided vehicle using the machine learning technique to determine the likelihood.

16. The method of claim 13, wherein the location information indicates a number of the iterations for which the actual location of the autonomous guided vehicle in the region is different from the intended location of the autonomous guided vehicle; and
wherein analyzing the location information comprises:
analyzing the number of the iterations for which the actual location of the autonomous guided vehicle in the region is different from the intended location of the autonomous guided vehicle using the machine learning technique to determine the likelihood.

17. The method of claim 13, further comprising:
determining a confidence in an accuracy of a map of the facility using the machine learning technique;
wherein analyzing the location information comprises:
analyzing the location information and taking into consideration the confidence in the accuracy of the map of the facility using the machine learning technique to determine the likelihood.

18. An autonomous guided vehicle comprising:
memory;
one or more processors coupled to the memory, the one or more processors configured to determine an intended location of the autonomous guided vehicle based at least in part on a previously determined location of the autonomous guided vehicle and further based at least in part on a calculated motion of the autonomous guided vehicle from the previously determined location; and
an RFID device configured to:
receive one or more interrogation signals from one or more active RFID readers, the RFID device paired with a plurality of active RFID readers that are attached to one or more objects in an environment of the autonomous guided vehicle, the plurality of active RFID readers including the one or more active RFID readers; and
transmit one or more response signals to the one or more active RFID readers in response to the one or more interrogation signals, the one or more response signals indicating receipt of the one or more interrogation signals by the RFID device,
the one or more processors further configured to set a reference location of the autonomous guided vehicle on which navigation of the autonomous guided vehicle is based to be an actual location of the autonomous guided vehicle, which is based at least in part on the one or more response signals, rather than the intended location as a result of the calculated motion of the autonomous guided vehicle from the previously determined location being different from an actual motion of the autonomous guided vehicle from the previously determined location.

19. The autonomous guided vehicle of claim 18, wherein the one or more processors are further configured to:
determine an intended orientation of the autonomous guided vehicle based at least in part on a previously determined orientation of the autonomous guided vehicle and further based on the calculated motion; and
set a reference orientation of the autonomous guided vehicle on which the navigation of the autonomous guided vehicle is based to be an actual orientation of the autonomous guided vehicle, which is based at least in part on the one or more response signals, rather than the intended orientation as a result of the calculated motion of the autonomous guided vehicle from the previously determined location being different from the actual motion of the autonomous guided vehicle from the previously determined location.

20. The autonomous guided vehicle of claim 18, wherein the RFID device includes a passive RFID tag.

21. The autonomous guided vehicle of claim 18, wherein the RFID device includes an active RFID tag.

22. The autonomous guided vehicle of claim 18, wherein the RFID device includes an active RFID reader.

23. The autonomous guided vehicle of claim 18, wherein the one or more processors and the RFID device are configured to collaborate to iteratively determine the intended location, receive the one or more interrogation signals, and transmit the one or more response signals, which results in location information that indicates whether the intended location is different from the actual location for each iteration of a plurality of iterations;
wherein the one or more processors are configured to:
analyze the location information using a machine learning technique to determine a likelihood that an actual location of the autonomous guided vehicle in a region of a facility is to be different from an intended location of the autonomous guided vehicle, the facility including the paired RFID devices; and
perform at least one of the following operations:
modify a computer software program that controls a path of the autonomous guided vehicle through the facility so that the path avoids the region based at least in part on the likelihood being greater than or equal to a threshold likelihood; or
provide a recommendation to at least one of (a) change a location of at least one active RFID reader in the environment of the autonomous guided vehicle or (b) add at least one active RFID reader in the environment of the autonomous guided vehicle to reduce the likelihood that the actual location of the autonomous guided vehicle in the region is to be different from the intended location of the autonomous guided vehicle.
